(19) United States
(12) Patent Application Publication
(10) Pub. No.: US 2017/0112126 A1
(43) Pub. Date: Apr. 27, 2017

(54) INSECTICIDE-CONTAINING COATING COMPOSITION AND METHOD FOR PROTECTING PALM TREES FROM PESTS

(71) Applicant: SABIC GLOBAL TECHNOLOGIES B.V., Bergen op Zoom (NL)

(72) Inventors: Andrea Alberto RETTORI, Torino (IT); Roberto MARTINIS, Torino (IT); Massimo PUGLIESE, Rivalta di Torino (IT); Maria Lodovica GULLINO, Torino (IT)

(73) Assignee: SABIC GLOBAL TECHNOLOGIES B.V., Bergen op Zoom (NL)

(21) Appl. No.: 15/317,915

(22) PCT Filed: Jun. 9, 2015
(86) PCT No.: PCT/IB2015/002032

§ 371 Date: Dec. 9, 2016

Related U.S. Application Data
(60) Provisional application No. 62/010,317, filed on Jun. 10, 2014.
(60) Provisional application No. 62/142,919, filed on Apr. 3, 2015.

(51) Int. Cl. A01N 25/24; A01N 53/00; A01N 57/16; C09D 191/00; C09D 131/04; C09J 11/06; C09J 131/04; C09J 191/00; A01N 25/00; C09D 5/14

(52) U.S. Cl. CPC A01N 25/24; A01N 25/00; A01N 53/00; A01N 57/16; C09D 5/14; C09D 131/04; C09J 11/06; C09J 131/04; C09J 191/005; C09D 191/005

(57) ABSTRACT

A palm plant treatment method, palm plant treatment layer, palm plant treatment composition and method of making the palm plant treatment composition that relates to a layer comprising an insecticide and a polymeric adhesive present on a palm plant surface that is effective for treating or preventing infestation of the palm plant by a pest without the insecticide entering the vascular system of the palm plant.

### BACKGROUND

Field of the Invention

The present invention relates to insecticide-containing coating compositions, surfaces of a plant coated with an insecticide-containing layer, and methods for protecting trees from insects, specifically coating compositions and methods for protecting palm trees from red palm weevils.

Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The red palm weevil, Rhynchophorus ferrugineus, infests palm trees worldwide, from Asia to Africa, Europe, Australia and North and South America. Adults are large reddish-brown beetles approximately three centimeters long, with a characteristic long curved rostrum. Adults have wings, and can fly long distances. Females lay about 200 eggs at the base of young leaves or in wounds to the leaves and trunk of trees.

Larvae of the red palm weevil feed on the soft fibers and terminal bud tissues of the tree, reaching a size of more than five centimeters. Before pupation, the larvae burrow into the trunks of palm trees, excavating holes up to a meter long. The larvae can be found anywhere within the palm, even in the very base of the trunk where the roots emerge. This burrowing weakens and eventually kills the tree. Although adult weevils can damage trees by feeding on them, larvae can cause greater damage by burrowing.

External symptoms of infestation include a progressive yellowing of the leaf area, destruction of the rising leaf and necrosis in the flowers. Leaves begin to dry in ascending order in the crown; the apical leaf bends and eventually drops. However, these external symptoms are not enough for a clear identification. Internally, the excavated holes and damage to leaf-stems produced by the larvae are easily detected in seriously infested trees. Pupae and old larvae are frequently found on the crown of infested plants. Affected plant tissue turns foul, producing strong characteristic odors. These symptoms are usually only visible long after the palm has become infested, however, and by the onset of visual symptoms the damage is usually sufficient to kill the tree.

Control of the red palm weevil is problematic for several reasons. Adults are mobile and easily bypass or evade containment barriers thereby expanding infestation outbreaks. Conventional pesticidal and insecticidal products, normally efficient against other infesting species, are inefficient against red palm weevil and fail to kill the parasite shortly after contact and/or fail to terminate infestation without compromising the viability and quality of the palm. Treatments are made even more difficult in that infestation often becomes evident only when the infestation is advanced and is characterized by a high number of differently distributed parasites in different life stages, e.g., egg, larva, pupa, emergent adult and/or adult. Some conventional insecticides are toxic to the palms and any resulting partial control of infestation is associated with a decay of viability and ornamental appearance of the palm.

Known methods of controlling the red palm weevil rely on systemic insecticides, for example applying an insecticide through a hole in the trunk above an infested area, or spraying an insecticide on the ground surrounding a palm. Such systemic insecticides enter the vascular system of the tree, including the phloem and xylem, and are transported throughout the plant or palm tree. Drawbacks to using systemic insecticides include the relatively large amount of insecticide required for effectiveness, and the loss of insecticide to the environment or seepage into ground water.

### SUMMARY OF THE INVENTION

The foregoing paragraphs have been provided by way of general introduction, and are not intended to limit the scope of the following claims. The described embodiments, together with further advantages, will be best understood by reference to the following detailed description taken in conjunction with the accompanying drawings.

One aspect of the present disclosure includes a palm plant treatment method that includes applying a composition comprising an insecticide and a polymeric adhesive to a palm plant to form an insecticide-containing layer that is effective for treating or preventing infestation of the palm plant by a pest without the insecticide entering the vascular system of the palm plant.

In another aspect the insecticide-containing layer of the treatment method is a homogenous mixture of the insecticide and the polymeric adhesive and is in direct contact with the surface of the palm plant

In another aspect of the treatment method the insecticide-containing layer contains a repellant.

In another aspect of the treatment method the insecticide-containing layer remains on the surface of the palm plant for at least 3 months during which there is no infestation of the palm tree by the pest.

In another aspect of the treatment method the insecticide is at least one of tefluthrin and chlorpyrifos.

In another aspect of the treatment method the pest is a red palm weevil and the palm plant is a palm tree.

In another aspect of the treatment method the polymeric adhesive is at least one of polyvinyl acetate and raw linseed oil.

In another aspect of the treatment method the palm plant is at least one of Phoenix dactylifera and Phoenix canariensis.

In another aspect of the treatment method the insecticide-containing layer continuously covers the severed and live leaf bases and petiole bases of the palm plant.

In another aspect of the treatment method the composition applied to the palm plant contains at least one of an aqueous solvent or an organic solvent.

A further aspect of the invention includes a pest resistant palm plant surface made from an exterior surface of a palm plant and an insecticide-containing layer that is effective for treating or preventing infestation of the palm plant by a pest without the insecticide entering the vascular system of the palm plant.

In another aspect of the pest resistant palm plant surface the insecticide-containing layer comprises a homogenous mixture of the insecticide and the polymeric adhesive,

In another aspect of the pest resistant palm plant surface the insecticide-containing layer contains a repellant.

In another aspect of the pest resistant palm plant surface the insecticide-containing layer is present on the surface of the palm plant in an amount and a thickness effective for preventing infestation of the palm plant by the pest for at least 3 months.

In another aspect of the pest resistant palm plant surface the insecticide is at least one of tefluthrin and chlorpyrifos.

In another aspect of the pest resistant palm plant surface the pest is a red palm weevil and the palm plant is a palm tree.

In another aspect of the pest resistant palm plant surface the polymeric adhesive is at least one of polyvinyl acetate and raw linseed oil.

In another aspect of the pest resistant palm plant surface the palm plant is at least one of Phoenix dactylifera and Phoenix canariensis.

In another aspect of the pest resistant palm plant surface is at the severed and live leaf bases and petiole bases of a palm plant.

A further aspect of the invention includes an insecticide for preventing infestation of palm trees by a red palm weevil containing a polyvinyl acetate adhesive and chlorpyrifos, wherein the chlorpyrifos is homogenously dispersed in the polyvinyl acetate adhesive.

In another aspect the insecticide includes camphor oil, which is homogenously dispersed in the polyvinyl acetate adhesive with the camphor oil.

A further aspect of the invention includes an insecticide for preventing infestation of palm trees by a red palm weevil containing a polyvinyl acetate adhesive and teflutrin such that the tefluthrin is homogenously dispersed in the polyvinyl acetate adhesive.

A further aspect of the insecticide contains and camphor oil, such that the teflutrin and the camphor oil are homogenously dispersed in the polyvinyl acetate adhesive.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a palm plant coated with an insecticide-containing at a leaf-trunk portion including a leaf base and a petiole base;

FIG. 2 shows the insecticide composition being applied to the base of the leaf stem by painting;

FIG. 3 shows a leaf surface covered with an insecticide-containing layer.

### DETAILED DESCRIPTION OF THE INVENTION

Conventional treatment methods for applying insecticides to palm trees utilize the vascular system of the plant to systemically deliver an insecticide. The palm tree trunk, which serves as a conduit for transporting nutrients from the roots of the palm tree to its crown, contains numerous hard fibrous-sheathed vascular bundles which are embedded in a matrix of water- and carbohydrate-storing parenchyma cells. The vascular bundles are dispersed throughout the diameter of the palm tree trunk which is covered and separated from the environment by a hard sheath epidermis.

The vascular bundles each contain a phloem and xylem portion serving to transport nutrients and moisture throughout the palm tree trunk. Within each vascular bundle the phloem functions to transport carbohydrates and the xylem functions to transport water and minerals. A cross section of a palm tree trunk shows several distinct regions including a central cylinder in which the vascular bundles are dispersed and a cortex representing the periphery of the palm tree trunk. The epidermis representing the outermost portion of the cortex comprises sclerified cells which are in some respects similar to the bark of a coniferous and/or deciduous tree or plant. The parenchyma cells of the central cylinder provide storage for both moisture and carbohydrates such as starch.

The underground portion of a palm tree is represented by a root system containing numerous non-woody roots initiating at a root zone and concentrated in a relatively small root ball. The roots of a palm tree serve to transport moisture and nutrients from the ground into the vascular system and into the crown and fruits of a mature palm tree.

The crown of the palm tree has a single meristem from which numerous leaf blades may emerge through a petiole. During a year's growth cycle of a palm tree, periods of leaf growth, maturity and fall are observed. Fruit appearing at inflorescences in the crown ripen to provide a sweet and nutritious fruit known as a date.

Palm trees do not have a peripheral vascular cambium but instead the vascular system is dispersed throughout the palm tree trunk. Palm tree trunks typically do not thicken substantially on growth but instead grow vertically. In contrast, deciduous and coniferous trees are characterized by a peripheral vascular cambium underneath a bark layer. This layer is able to withstand damage and regenerate or repair trauma suffered by the tree. Palm trees on the other hand do not have this repair mechanism.

The absence of a peripheral vascular cambium places palm trees in danger of mortality when their internal tissues are damaged. For example, the burrowing red palm weevil larvae may intersect and sever vascular bundles inside the palm tree's trunk and thereby disrupt the vascular system and impede the transport of nutrients within the palm tree. Palm trees are especially susceptible to pests that have entered the interior portion of the palm tree trunk.

Conventional treatment methods for palm trees infected with pests such as the red palm weevil include administering an insecticide either directly to the tree or in the ground surrounding the tree. The pesticide is applied as a composition that includes a carrier and, optionally, a penetrant. In ground applications the insecticide is absorbed by the root bundle of the palm tree then dispersed and transported through the vascular system of the palm tree. Application of insecticide compositions to the trunk or leaf portions of a palm tree are also intended to result in transport of the insecticide from the exterior portion of the leaf and/or trunk portions of the palm tree into the palm tree's vascular system.

Conventional methods of applying insecticides to palm trees have significant disadvantages. Conventional spraying or ground application requires transport of the insecticide throughout the palm tree's vascular system. As a pest ingests or chews on a portion of the palm tree the insecticide is absorbed by the pest. The insecticide is present throughout the vascular system of the palm tree including the trunk, palm tree leaves, palm tree roots and/or fruit. Systemic application of the insecticide requires a relatively large amount of insecticide to treat an individual tree. Only a small portion of the systemically applied insecticide is delivered directly to a targeted portion of the palm tree or a targeted pest. Moreover, dispersal of the insecticide throughout the entire internal portion of the tree's vascular system requires that a relatively high insecticide dosage be administered in order to deliver a lethal dose to an insect or pest penetrating, ingesting or otherwise damaging any portion of the palm tree.

The conventional application of an insecticide to the root portion of a palm tree requires even greater quantity of insecticide than conventional application to the trunk or crown. Not all of the insecticide applied to the ground beneath a palm tree is absorbed and transported within the palm tree's vascular system and thus ground application is especially inefficient. Of course, ground application of insecticide has other disadvantages such as risk of contamination of ground water supplies.

Conventional means of applying insecticide to palm trees are therefore substantially disadvantaged with respect to the quantity of insecticide that must be applied in order to effectively protect, treat or prevent infestation. Systemic application and transport of insecticide through the palm tree vascular system results in relatively short term protection or treatment. Insecticide may be subject to decomposition and degradation by biological processes occurring within the palm tree's vascular system and/or the insecticide may be lost over time as the palm tree sheds leaves, pollen, sap or fruit. Further, systemic application of insecticide risks inclusion of insecticide into the fruit portion of a palm tree thus placing at risk the use of the palm tree as a food source.

As the term is used herein, transport of the insecticide from the insecticide-containing layer into the vascular system of the tree does not include transport of the insecticide into the palm tree by the red palm weevil or by another pest. For example, a red palm larva weevil that begins burrowing into a palm tree will ingest a lethal dose of the insecticide as the larva burrows through the insecticide-containing layer that is present on the exterior of the palm tree. While the red palm weevil may have ingested a lethal dose of the insecticide when burrowing into the plant, the larva is not killed until after having at least partially entered the central cylinder or cortex of the palm tree trunk. Any insecticide that is transported into the interior of the palm tree by a pest, for the purposes of the present disclosure, is not considered to have migrated or have been transported from the insecticide-containing layer into the palm tree, i.e., the insecticide-containing layer does not function to transport the insecticide into the plant's vascular system.

Aspects of the present disclosure include an insecticide-containing layer and a method for applying the insecticide layer to a palm tree in an amount or thickness effective to protect against or treat infestation by the red palm weevil and/or other pests of the palm tree and/or other plant. The application of a long-lived insecticide-containing layer to exterior portions of a palm tree provides several significant advantages in comparison to conventional treatment compositions and methods. An insecticide-containing layer on exterior surfaces of the palm tree provides a first layer of defense against infestation of the palm tree and/or a first layer of defense against penetration by a burrowing pest. When a pest such as a red palm weevil lays an egg on the insecticide-containing layer the resultant hatchling larva must first burrow through the insecticide-containing layer, epidermis and/or leaf surfaces of the palm tree before entering the cortex and central cylinder of the palm tree trunk or the vascular system of the leaves or roots.

As the red palm weevil larvae burrow through the insecticide-containing layer an effective or lethal dose of insecticide is absorbed by the pest. Early ingestion of the insecticide by the pest kills quickly and minimizes and/or eliminates damage caused by further burrowing or destruction of the palm tree cortex, vascular system or structural integrity of the palm tree trunk. An insecticide-containing layer is also effective for controlling infestations during which insects emerge from a palm tree prior to reproduction. While burrowing out of or emerging from a palm tree the mature larvae ingest a lethal dosage of the insecticide which results in death of the emerging insect and disruption of the insect's reproduction cycle. In this way heavy pest infestations can be disrupted before significant tree damage occurs.

The use of an insecticide-containing layer eliminates the need for systemic insecticide dispersal through the palm tree's vascular system. Using an external insecticide-containing layer provides a means for effectively protecting against red palm weevil attack and infestation using a significantly lower amount of pesticide than would otherwise be used for conventional treatment. Application of insecticide to the root system of the palm tree may be completely eliminated using only an insecticide-containing layer. Likewise, the application of an insecticide-containing layer on the external portions of a palm tree may entirely eliminate the need for injecting any insecticide into the vascular portion of the palm tree plant. This strategy for applying an insecticide-coating layer may entirely eliminate the presence of insecticide anywhere within the vascular system or interior cells of the palm tree plant.

The insecticide-containing layer may be applied to any external portion of the palm tree including the palm tree trunk, the crown, the leaves, the leaf stem, the root initiation zone and/or the surface of the ground surrounding the root initiation zone immediately under the palm tree. Preferably the insecticide-coating layer is applied to all exterior exposed surfaces of the palm tree including the root initiation zone (above ground portion), the palm tree trunk and all portions of the palm tree crown. Preferably the majority of the external surfaces of the palm tree are covered with the insecticide-containing layer including a major portion of the palm tree trunk, a major portion of the palm tree crown including leaves, and a major portion of the root initiation zone.

It is not necessary that the insecticide-containing layer cover 100% of the area of each surface of the palm tree. It is also not necessary that the insecticide-containing layer provide continuous and uninterrupted coverage of the entire palm tree plant. The insecticide-containing layer typically has discontinuities and is uneven in thickness on any surface of the trunk, crown or leaves.

It is advantageous that at least 50% of the entire surface of any of the palm tree trunk, the palm tree crown and/or the palm tree leaves are coated with the insecticide-containing layer, preferably at least 60%, 70%, 80% and most preferably at least 90%. Coverage of the insecticide-containing layer on the palm tree may be determined by several methods including a visual inspection in which the composition that is applied to the palm tree to form the insecticide-containing layer includes a dye permitting visual determination of the degree and uniformity of the insecticide-containing layer. Surface characterization techniques such as infrared and/or fluorescence can also be used to determine the degree of coverage of the palm tree surface.

Preferably the palm tree includes an area that is 100% covered with the insecticide-coating layer. Such areas may represent at least 100 square centimeters, at least 1 square meter, at least 5 square meters and/or at least 10 square meters. Although the insecticide-containing layer is not uniformly dispersed over the entire surface of the palm tree, it is continuous and provides a sufficient dosage of insecticide to effectively prevent infestation and/or propagation of an infestation in a palm tree.

The insecticide-containing layer is preferably a homogeneous layer in which the insecticide is homogeneously dispersed. The insecticide molecules are present in the insecticide-containing layer in direct chemical and physical contact with the polymeric adhesive which is used to form the insecticide-containing layer. The insecticide is not otherwise separated from the polymeric adhesive, preferably the insecticide is not present in the form of capsules, microcapsules or other physical containers that function to prohibit direct contact between the insecticide molecules and the matrix of polymeric adhesive.

In other aspects of the invention the insecticide-containing layer is present in one or more layers distinct from one or more other layers of an adhesive-containing composition that is otherwise free of the insecticide. For example, a first adhesive-containing composition may be applied to the bark of a palm tree to form a first layer. The first layer which is in direct contact with the palm tree preferably does not contain any pesticide tefluthrin or chlorpyrifos insecticide. The first layer may, however, contain one or more naturally-occurring insect repellants such as camphor oil, any of the insect repellant components present therein and/or a pyrethrin.

Although it is preferable that the first layer is free of a synthetic pesticide, in other embodiments the first layer may contain an amount of pesticide that is less than the amount of pesticide in any other layer subsequently applied to the first layer. The first layer may also contain one or more additional adhesives to make a longer lasting bond or weather durable bond between the first layer and the bark or the exterior of the palm tree that would otherwise be utilizing the insecticide-containing adhesive composition. For example, a matrix containing certain polymer species may be preferable in order to obtain advantageous immobilization of a pesticide within a layer. Such pesticide immobilization may, however, result in decreased adhesion to the exterior portion of a palm tree. In one embodiment the reduced adhesion to the palm tree is balanced by applying a first layer of adhesive composition that is free of the pesticide and has stronger bonding, improved weatherability and/or longer lasting bonding and compatibility with the palm tree. A subsequent layer that is in direct contact with the first layer may be an insecticide-containing layer having improved adhesion to the first layer in comparison to adhesion directly to the exterior of the palm tree.

One or more additional insecticide-containing or insecticide-free layers may then be applied to the insecticide-containing layer to protect and/or enhance the activity of the insecticide-containing layer. In this manner a multi-layer structure may be applied to a palm tree. A first layer may be insecticide-free and formed from a first adhesive-containing composition. One or more subsequent layers may contain the same insecticide or a different insecticide with one or more different or identical adhesive polymer compositions. The insecticide concentration may be represented as a gradient beginning from a layer that is in direct contact with the palm tree and having a minimum or zero level of insecticide to a heightened insecticide concentration maximized at the exterior portion of the gradient.

In another aspect the immobilization, weather fastness and preservation (lack of degradation/efficacy) properties of the insecticide are improved by including one or more outer adhesive-containing layers having no pesticide or an amount of insecticide that is less than the amount of insecticide in one or more interior layers. The thickness and coverage amounts of any of the aforementioned layers may be the same as the layer thicknesses disclosed herein for other layers.

In one embodiment of the invention the outermost layer of insecticide-containing composition present on a palm tree surface has the greatest amount of insecticide in comparison to any other layer or any other portion of a layer that is in direct or indirect contact with the palm tree surface. A high concentration of insecticide on an outermost surface ensures that insecticide most quickly enters a pest upon ingestion by activity such as burrowing through the insecticide-containing layer.

The insecticide-containing layer is present on the surface of the palm tree in a thickness that is sufficient for ingestion of a lethal dose of insecticide by a pest attempting to enter or bore into the palm tree. The thickness of the insecticide-containing layer may vary depending on the concentration of insecticide present therein. In embodiments the pesticide-containing layer has a thickness of from 10 μm to 1 millimeter, preferably from 50 μm to 950 μm, from 100 μm to 900 μm, 150 μm to 850 μm, 200 μm to 800 μm, 250 μm to 750 μm, 300 μm to 700 μm, 350 μm to 650 μm, 400 μm to 600 μm, 450 μm to 550 μm or about 500 μm. The thickness of the insecticide-containing layer is an average determined by cross sectional analysis or the use of a thickness gauge such as an Erichsen 455 paint inspection gauge.

The insecticide-containing layer comprises an insecticidally-effective amount of one or more of the insecticides. The term “insecticidally-effective amount” describes a concentration of insecticide in the insecticide-containing layer sufficient to deliver a lethal and/or repellent dose of insecticide to a pest as it ingests or absorbs a portion of the insecticide-containing layer while feeding on a palm tree coated with the insecticide-containing layer or attempting to burrow into the palm tree through the insecticide-containing layer. An insecticidally-effective amount is an amount sufficient to kill the pest in one or more of its life cycle forms including pupa, egg, larva, emergent and adult. A repellent-effective amount is an amount that is sufficient for deterring a pest from penetrating the epidermis or cortex of a palm tree and/or an amount sufficient to deter a pest from depositing an egg thereon.

The amount of insecticide that is present in the insecticide-containing layer may vary depending on the effectiveness (lethality) of the pesticide. A pesticide such as tefluthrin is preferably present in an amount of from 0.01 to 1% by weight, more preferably 0.05 to 0.9% by weight, 0.1 to 0.8% by weight, 0.2 to 0.7% by weight, 0.3 to 0.6% by weight or 0.4 to 0.5% by weight where % by weight is based on the total weight of the insecticide-containing layer and the total weight of the insecticide. The total weight of the insecticide-containing layer may be determined based on the total weight of the composition applied to the palm tree to form the insecticide-containing layer not including a solvent portion such as water and/or an organic solvent.

An insecticide such as chlorpyrifos is preferably present in an amount of from 0.1-5% by weight, more preferably 0.2-4.5% by weight, 0.3-4% by weight, 0.4-3.5% by weight, 0.5-3% by weight, 0.6-2.5% by weight, 0.7-2.0% by weight, 0.8-1.5% by weight, 0.9-1.0% by weight.

The amount of insecticide present in the cured layer present on a palm tree surface may also be expressed in terms of multiples of the LD₅₀ of the insecticide. For example, the insecticide may be present in one or more insecticide-containing layers in an amount of 0.1-50× the LD₅₀, preferably 0.5-40× the LD₅₀, preferably 1-40× the LD₅₀, preferably 2-30× the LD₅₀, preferably 3-25× the LD₅₀, preferably 4-20× the LD₅₀, preferably 5-15× the LD₅₀, preferably 6-12× the LD₅₀, preferably 7-10× the LD₅₀, preferably 8-9× the LD₅₀.

The amount of pesticide present in the insecticide-containing layer may also be expressed as a matter of weight per area. The amount of insecticide may be, for example, 1-200 micrograms/cm², 5-150 μg/cm², 2-125 μg/cm², 3-120 μg/cm², 4-110 μg/cm², 5-100 μg/cm², 6-90 μg/cm², 7-80 μg/cm², 8-70 μg/cm², 9-60 μg/cm², 10-50 μg/cm², 15-45 μg/cm², 20-30 μg/cm².

Secondary insecticides may be present in equal amounts or amounts present as a fraction or multiple of the amount of one or more other insecticides such as 0.1, 0.5, 1.0, 1.5 or 5 times the amount of a primary insecticide such as tefluthrin or chlorpyrifos.

Diffusion of insecticide from any one of the layers present on a palm tree surface is desirably minimized in order to reduce loss of insecticide, improve the effective time of the insecticide-containing layer and to reduce contamination of the environment with insecticide from an insecticide-containing layer.

Advantageously the insecticide-containing layer present on the palm tree has an effective lifetime of preferably more than six months, eight months, ten months and most preferably more than one year. An effective lifetime for an insecticide-containing layer corresponds with then ability for the layers to repel and/or kill a red palm weevil attack with no more than a 5% infestation rate six months, eight months, ten months or one year after exposure to red palm weevils. In order to achieve an improved effective lifetime both the immobilization and weather fastness of the pesticide is preferably ensured. Immobilization is improved with adhesive-containing polymer compositions that are based on vinyl acetate. One or more additional polymer materials may be present in an amount of 10-50%, 20-40% or about 30% by weight based on the total weight of the polymer materials in the adhesive-containing composition. Addition of one or more functionalized vinyl acetate materials may thus improve the ability of the insecticide to be immobilized in one or more layers present on a palm tree. Immobilization may also be enhanced by separating one or more insecticide-containing layers from one or more other layers that are substantially or totally free of insecticide.

Weather fastness may likewise be important to maintaining an effective amount of insecticide for repelling and/or killing the red palm weevil. Under the harsh temperature and light exposure conditions often encountered for palm trees, it is important for the insecticide-containing layer to remain adhered to a palm tree surface and to maintain its capability to immobilize an insecticide. The weather fastness of a particular adhesive and insecticide-containing layer may be measured with a weatherometer under test conditions specified in ASTM D4329, ASTM D4587, ISO 4892, SAE J2020, ASTM D2565, ASTM D4459, G155, SAEJ 1885, J1960 where such tests function to describe the weather fastness, adhesion to tree surface and/or insecticide immobilization properties.

Certain palm trees are shedding and naturally drop their leaves during cycles of growth. As a palm tree grows vertically the leaf base and/or point of attachment of a shed leaf remains visible on a palm tree trunk. Effective treatment of palm infestation and/or prevention of pest infestation of a palm tree requires application and presence of the insecticide-coating layer on surfaces near to and around the point of attachment of a palm leaf to a palm tree trunk. The insecticide-containing layer must therefore provide coverage of both the leaf base and petiole base portions of existing leaves and leaves which have been shed and/or cut from the palm tree leaving a leaf base and/or point of attachment evident on the palm tree trunk. Preferably leaf base portions of both shed leaves and live leaves are fully coated with the insecticide-containing layer. The point of attachment, leaf base and petiole base of a palm leaf to a palm tree trunk is recognized as a favored point of infestation by the red palm weevil.

For palm tree species which do not naturally shed leaves but instead retain dead leaves attached to the palm tree trunk, effective control and prevention of red palm weevil infestation is preferably accomplished by complete coating of the attachment point of each leaf base to the palm tree trunk and/or leaf base or leaf base petiole. For dead leaves which have been artificially removed (e.g., cut) from a palm tree trunk are likewise preferably fully coated with the insecticide-containing layer including the leaf cross-section which remains exposed after cutting of the dead leaf.

Within the crown and/or canopy of the palm tree preferably the entire surface of the palm tree leaf including the leaf base, petiole base, petiole, rachis, spines, leaflet and leaf tip are coated with the insecticide-containing layer together with any florescence or growth portions present at the growth point or meristem of the palm tree plant. Likewise, a inflorescence of any stage of the growth cycle of a palm tree plant is coated with the insecticide-containing layer in order to obtain complete and effective control of red palm weevil infestation or prevention of infestation by red palm weevil. Dropped or cut leaves leave marks on the palm tree trunk which are commonly referred to as leaf scars. Portions of the leaf scars representing the previous live leaf including the leaf base and petiole base are preferably coated with the insecticide-containing layer. Likewise wounds present on the palm tree trunk are preferably coated with the insecticide-containing layer.

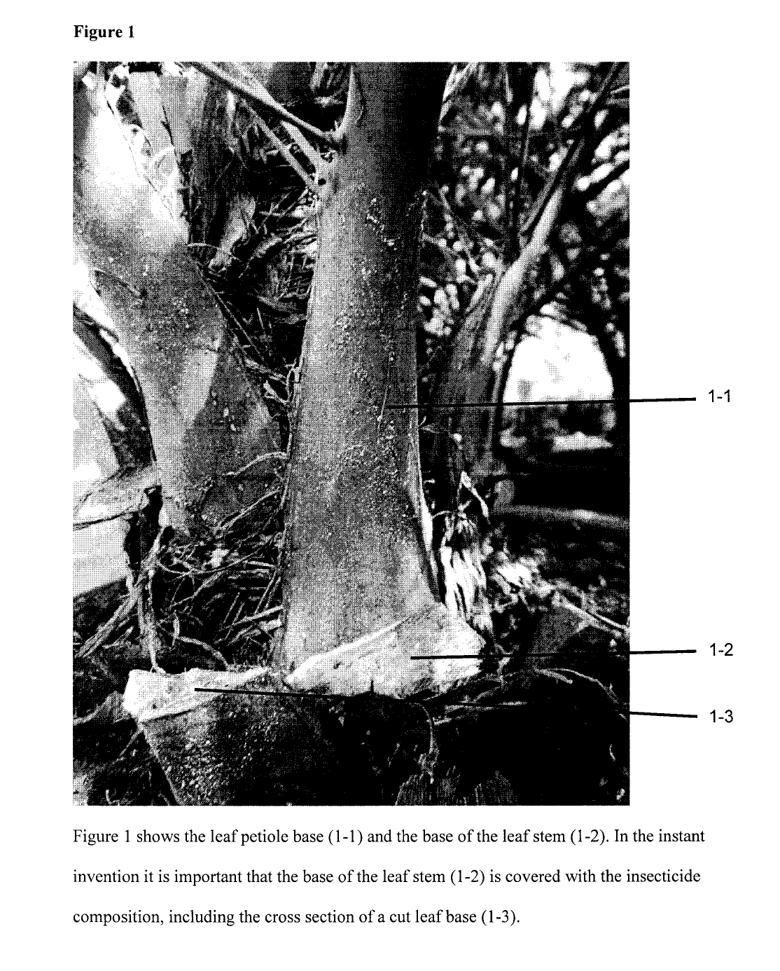

FIG. 1 shows a palm plant that has been treated with the insecticide-containing composition described herein. An insecticide-containing layer is present on portions of the palm plant including at the base of the leaf stem (1-2) and at the base of the leaf petiole (1-1). A cross-section of a previous live palm leaf is shown as (1-3). The internal portion of the base of leaf stem is covered with the insecticide-containing layer. This further ensures that any eggs laid by a beetle are laid onto the insecticide-containing layer. Beetles that have a tendency to lay eggs at the portion of the palm plant where the leaf base meets and enters the tree trunk, e.g., where eggs are deposited between the base of leaf stem, can therefore be treated. The insecticide-containing layer is present on the cross-sectional cut surface of the old leaf. The portions of the palm tree where a leaf base meets the palm tree trunk and especially such areas which include green and live leaf surfaces near the trunk are most susceptible to attack by the red palm weevil.

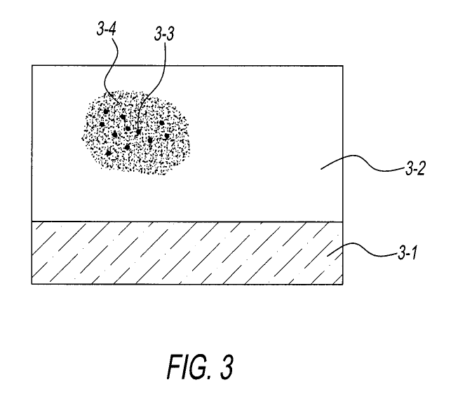

FIG. 3 shows a leaf surface that is coated with the insecticide-containing layer described herein. The leaf surface represents a substrate (3-1) which is in direct and continuous contact with the insecticide-containing layer (3-2). The insecticide-containing layer (3-2) includes molecules of insecticide (3-3) homogeneously dispersed throughout the polymer adhesive matrix (3-4). In this respect the insecticide-containing layer represents a single solid phase in which the insecticide is evenly and homogeneously dispersed. The insecticide is effectively immobilized in the insecticide-containing layer which is in solid form and resists egress of the insecticide by diffusion or transport and/or loss of the insecticide by erosion.

As used herein a “surface” of a palm tree is an outer boundary of any portion of the palm tree and the environment surrounding the tree, e.g., an exterior surface of a plant that is sufficiently exposed to permit application of a liquid composition and formation of an insecticide-containing layer thereon.

The method, composition and layer described herein are effective on plants including palm trees such as coconut palm (Cocos nucifera), oil palm (Elaeis guineensis), Areca catechu, Arenga pinnata, Borassus flabellifer, Calamus merillii, Cargota maxima, Cargota cumingii, Corypha gebanga, Corypha elata, Livistona decipiens, Metroxglon sagu, Oreodoxa regia, Phoenix sylvestris, Sabal umbraculifera, Trachycarpus fortunei, Washingtonia spp., and other palm like plants such as Agave Americana, Saccharum officinarum, and Chamaerops humilis (known as Mediterranean dwarf Palm). Preferably the palm trees of the Phoenix canariensis and Phoenix dactylifera are treated.

The palm plants and palm trees to which the insecticide layer is applied may be in different growth stages. In an early juvenile phase the palm tree may be in the form of a shrub, vine or seedling. In more mature phases the palm tree exhibits a characteristic trunk topped by a crown of palm leaves. The palm trees to which the insecticide layer is applied may be positioned sparsely or at high density with respect to one another. For example, the palm trees may be located close to one another in the form of an orchard or organized growing pattern.

The insecticide is effective for preventing and/or treating infestations of numerous insect pests including the red palm weevil. Other insects that may be effectively treated include the following: (1) Coleptera family insects such as Callosobruchus Chinensis (adzuki bean weevil), sitophilus zeamais (maize weevil), Tribolium castaneum (red flour beetle), Epilachna vigintioctomaculata (large 28-spotted lady beetle), Agriotes fuscicollis (barley wireworm), Anomala rufocuprea (soybean beetle), Leptinotarsa decemlineata, Diabrotica spp., Monochamus alternatus (Japanese pine sawyer), Lissorhoptrus oryzophilus (rice water weevil), Lyctus (powderpost beetle), etc.; (2) Lepidoptera family insects such as Lymantria dispar (gypsy moth), Malacosoma neustria, Pieris rapae, Spodoptera litura (common cutworm), Mamestra brassicae (cabbage armyworm), Chilo suppressalis (Asiatic rice borer), Pyrausta nubilalis (oriental corn borer), Ephestia cautella, Adoxophyes orana (smaller tea tortrix), Carpocapsa pomonella, Agrotis (cutworm), Galleria mellonella (greater wax moth), Plutella maculipennis (diamondback moth), Heliothis Phyllocnistis citrella, etc.; (3) Hemiptera family insects such as Nephotettix cincticeps (green rice leafhopper), Nilaparvata lugens (brown rice planthopper), Pseudococcus comstocki (Comstock mealyburg), Unaspis yanonensis (arrowhead scale), Myzus persicae (green peach aphid), Aphis pomi (green apple aphis), Aphis gossypii (cotton aphid), Rhopalosiphum pseuddobrassicas (turnip aphid), Stephanitis nashi (pear lace bug), Nazara spp., Cimex lectularius, Trialeurodes vaporariorum (greenhouse whitefly), Psylla spp. (jumping plantlice), etc.; (4) Orthoptera family insects such as Blatella germanica (German cockroach), Periplaneta americana (American cockroach), Gryllotalpa africana (mole cricket), Locusta migratoria migratoriodes, etc.; (5) Isoptera family insects such as Reticulitermes speratus (Japanese white birch aphid), Coptotermes formosanus (Formosan subterranean termite), etc., Thysanoptera, such as Thrips palmi karny; (6) Diptera family insects such as Musaca domestica (oriental house fly), Aedes aegypti, Hylemia platura (seed-corn maggot), Culex pipiens, Anopheles sinensis, Culex tritaeniorhynchus, etc.; (7) Acarina family insects such as Tetranychus telarius (carmine spider mite), (tow-spotted spider mite), Panonychus citri (citus red mite), Aculops pelekassi (pink citrus rust mite), Tarsonemus spp. (tarsonemid mites), etc.; and (8) Nematoda family insects such as Meloidogyne incognita (southern root-knot nematode), Bursaphelenchus lignicolus mamiya et kiyohara, Aphelenchoides bessey (rice white-tip nematode), Heterodera glycines (soybean cyst nematode), Pratylenchus spp. (root-lesion nematode), etc.

In a further embodiment of the disclosure a layer of an inorganic or organic filler or support material may be applied to the insecticide-containing layer present on the palm tree surface. An externally applied filler or support material may serve several purposes. Application of an irritant such as diatomaceous earth provides a primary physical barrier against attack by insects. In the same manner an organic support material such as a polymeric or inorganic fiber functions to physically impede attack by pests and to improve the lifetime, durability and adhesion of the insecticide-containing layer on the palm tree surface.

An externally applied filler or support is preferably applied soon after initial application of the insecticide-containing layer and/or insecticide-containing composition. The presence of the polymeric adhesive in the insecticide-coating layer serves to capture and hold the externally applied material whether applied in solid form (e.g., applied as a powder) or applied as a dispersion in a carrier or liquid such as water or an organic solvent.

In other embodiments of the invention the surface of the palm tree may be first coated with an organic or inorganic substance that is free of a pesticide for treating red palm weevil. In one embodiment a first layer of a polymeric adhesive that is the same or different from the polymeric adhesive in which the insecticide is dispersed is applied to the palm tree to provide a layer that consists essentially of the polymeric adhesive and is absent any insecticide. Subsequently one or more additional layers may be applied to the adhesive layer including the insecticide-containing layer in an amount or thickness that is effective for treating and preventing infestation by red palm weevil. Further optionally, an exterior layer or coating may be applied to the insecticide-containing layer to provide protection from the elements and/or to increase the lifetime of the insecticide-containing layer. Such an outermost layer may be of any thickness that is effective for providing additional protection to the insecticide-containing layer and may have layers of thickness equal to or equivalent to the insecticide-containing layer thicknesses described herein.

The insecticide-coating layer contains at least one polymeric adhesive and at least one insecticide. The adhesive serves to maintain the presence of the insecticide on an exterior surface of the palm tree. The adhesive entraps the insecticide in a polymeric adhesive matrix such that the insecticide substantially does not migrate or transport from the insecticide-coating layer into the vascular system of the palm tree. In addition, the polymeric adhesive helps provide a long term presence of the insecticide on the palm tree surface. In the absence of the polymeric adhesive an insecticide that is conventionally applied to the external surfaces of a palm tree is subject to quick degradation and stress under environmental effects including rainfall, sunshine and disturbances such as dust storms.

The insecticide may be any single insecticide or combination of insecticides including: carbamates, sodium channel modulators/voltage dependent sodium channel blockers, pyrethroids such as DDT, oxadiazines such as indoxacarb, acetylcholine-receptor agonists/antagonists, acetylcholine-receptor-modulators, nicotine, bensultap, cartap, chloronicotyinyls such as acetamiprid, clothianidin, dinotefuran, imidac loprid, nitenpyram, nithiazine, thiacloprid, and thiamethoxam, spinosyns such as spinosad, cyclodiene organochlorines such as camphechlor, chlordane, endosulfan, gamma-HCH, HCH, heptachlor, lindane, methoxychlor, fiproles such as acetoprole, ethiprole, fipronil, vaniliprole, chloride-channel, 6.1 mectins such as avermectin, emamectin, emamectin-benzoate, ivermectin, and milbemycin, juvenile-hormone mimics such as diofenolan, epofenonane, fenoxycarb, hydroprene, kinoprene, methoprene, pyriproxyfen, and triprene, ecdysone agonists/disruptors, diacylhydrazine, chromafenozide, halofenozide, methoxyfenozide, tebufenozide, chitin biosynthesis inhibitors, benzoylureas such as bistrifluron, chlorfluazuron, diflubenzuron, fluazuron, flucycloxuron, flufenoxuron, hexaflumuron, lufenuron, novaluron, noviflumuron, penfluron, teflubenzuron, triflumuron, buprofezin, cyromazine, oxidative phosphorylation inhibitors, ATP disruptors, diafenthiuron, organotins such as azocyclotin, cyhexatin, fenbutatin-oxide, pyrroles such as chlorfenapyr, dinitrophenols such as binapacryl, dinobuton, dinocap, DNOC, site-I electron transport inhibitors, METI's such as fenazaquin, fenpyroximate, pyrimidifen, pyridaben, tebufenpyrad, tolfenpyrad, hydramethyinon, dicofol, rotenone, acequinocyl, fluacrypyrim, spirodiclofen, spiromesifen, tetramic acids, carboxamides such as flonicamid, octopaminergic agonists such as amitraz, magnesium-stimulated ATPase inhibitors such as propargite, BDCA's such as N2-[1,1-dimethyl-2-(methylsulfonyl)ethyl]-3-iodo-N1-[2-methyl-4-[1,2,2,2-tetrafluoro-1-(trifluoromethyl)ethyl]phenyl]-1,2-benzene, nereistoxin analogues such as thiocyclam hydrogen oxalate, and thiosultap sodium. Preferably the insecticide is one or more of chlorpyrifos and tefluthrin.

The insecticides used in the insecticide-containing layer may include biological microorganisms suitable for controlling undesirable animal and plant pests and nuisance pests (such as harmful arthropods and nematodes, broad-leaved weeds and grass weeds, harmful bacteria and fungi). In general, the activity of these microorganism insecticides is based on the antagonistic action (parasitization, toxin formation, competition behavior) of the micororganisms against pests, resulting in their containment or destruction.

Preferred biological microorganism insecticides include all microorganisms (bacteria and fungi) capable of forming resting forms, such as spores or conidia. The microorganisms can be present in the insecticide-containing layer in various forms and development stages (for example in the form of mycelia, spores, blastospores etc.). Preferably, they are present as resting forms, in particular in the form of spores or conidia.

The formation of resting forms, in particular blastospores, spores and conidia, can be effected by a multitude of microorganisms (bacteria, fuingi), preferably by fungi from the taxonomic classes of the Phycomycetes, Ascomycetes, for example Chaetomium, Basidiomycetes and Deuteromycetes, in particular by the representatives of the Fungi imperfecti, such as, for example, various species of Aspergillus, Altemnaria, Aphanocladium, Beauveria, Coniothyrium, Colletotrichum, Meria (Drechmeria), Penicillium, Fusarium, Gliocladium, Pseudocercosporella, Trichoderma, Verticillium, Paecilamyces, in particular also of Metarhizium and Gliocladium, especially preferably of Metarhizium. Numerous strains of these fungi exhibit an antagonistic activity towards soil-borne, phytopathogenic fungi, such as, for example, Trichoderma hamatum and Glioclacium roseum, Gliocladium virens or apathogenic strains of otherwise phytophathogenic strains, such as, for example, apathogenic Fusarium oxysporum strains, against weeds, such as, for example, Alternatia cassiae, Fusarium lateritum, Fusarium solani, or against harmful insects, such as, for example, Verticillium lecanii, Aspergillus parasiticus, and in particular Metarhizium anisopliae. Examples of bacteria which can be used include Bacillus thuringiensis and Bacillus subtilis. Preferred microorganisms are fungicidal, nematopathogenic and entomophathogenic microorganisms (in particular fungi from the class Deuteromycetes). Especially preferred are nematophatogenic and entomophatogenic microorganisms.

The polymeric adhesive is preferably a vinyl acetate and/or vinyl alcohol-derived polymeric adhesive. The polymeric adhesive may be synthetic or derived from naturally occurring plant extracts such as linseed oil, and may be thermoplastic or thermoset.

Synthetic adhesives including elastomers, thermoplastics, emulsions, and thermosets such as thermosetting adhesives, epoxy, polyurethane, cyanoacrylate, acrylic polymers, pressure-sensitive adhesive may be used.

Natural adhesives may be made from organic sources such as vegetable starch (dextrin-soya), natural resins, or animals (e.g., gelatin, blood, milk protein casein and hide-based animal glues) as well as asphalt and bitumen based glues. Starch based adhesives, casein glue, albumen glue, lignin glue may be used.

A natural polymeric adhesive includes linseed oil which, in its natural and fresh form, is a triglyceride derived, for example from linoleic acid, alpha-linoleic acid and/or oleic acid. Heat treating a naturally occurring organic material such as linseed oil leads to polymerization and formation of a polymeric adhesive that may function to entrap and immobilize an insecticide.

The polymeric adhesive is preferably a viscoelastic material which adheres instantaneously to most substrates with the application of very slight pressure and remains tacky. Adhesives include mixtures of different polymers, copolymers and mixtures of polymers, such as polyisobutylenes (PIB), hydrocarbon polymers such as natural and synthetic polyisoprene, polybutylene and polyisobutylene, styrene/butadiene polymers styrene-isoprene-styrene block copolymers, hydrocarbon polymers such as butyl rubber, halogen-containing polymers such as polyacrylic-nitrile, polytetrafluoroethylene, polyvinylchloride, polyvinylidene chloride, polyvinyl acetate, methyl cellulose, polyvinyl alcohol, polyacrylics, polyacrylates, cellulose, polyvinylpyrrolidone, polysaccharides, natural and synthetic latexes, and polychlorodiene, and copolymers, graft polymers and mixtures thereof. The polymeric adhesive is preferably the major portion by weight of the matrix (cured layer) in which the insecticide is present on the palm tree.

Other useful adhesives include acrylic-based adhesives and silicone-based as described in U.S. Pat. Nos. 5,474,783, and 5,656,386 (each incorporated by reference in its entirety), including pressure-sensitive adhesives. Suitable commercially available acrylic-based polymers include commercially available adhesives such as polyacrylate adhesives sold under the trademarks Duro-Tak by National Starch and Chemical Corporation, Bridgewater, N.J., such as Duro-Tak 87-2194, Duro-Tak 87-2196, Duro-Tak 87-1197, 87-4194, 87-2510, 87-2097 and 87-2852. Other suitable acrylic-based adhesives are those sold under the trademarks Gelva-Multipolymer Solution (GMS) (Monsanto; St. Louis, Mo.), such as GMS 737, 788, 1151, 3087 and 7882.

Suitable silicone-based adhesives can include those described in Sobieski, et al., “Silicone Pressure Sensitive Adhesives,” Handbook of Pressure-Sensitive Adhesive Technology, 2nd ed., pp. 508-517 (D. Satas, ed.), Van Nostrand Reinhold, N.Y. (1989), incorporated by reference in its entirety. Other useful silicone-based pressure sensitive adhesives are described in the following U.S. patents: U.S. Pat. Nos. 4,591,622; 4,584,355; 4,585,836; and 4,655,767 (each incorporated by reference in its entirety). Suitable silicone-based pressure-sensitive adhesives are commercially available and include the silicone adhesives sold under the trademarks BIO-PSA 7-4503, BIO-PSA 7-4603, BIO-PSA 7-4301, 7-4202, 7-4102, 7-4106, and BIO-PSA 7-4303 by Dow Corning Corporation, Medical Products, Midland, Mich.

The polymer adhesive may be a reactive adhesive, a non-reactive adhesive or combinations of adhesives. A reactive adhesive is one that undergoes a chemical reaction to harden or set. Polymer adhesive of natural or synthetic origin may be used. A non-reactive adhesive, e.g., a drying adhesive, is preferred. In this form the adhesive is applied as a composition that forms an adhesive surface or adheres to a substrate upon drying, e.g., the removal of a solvent or dispersion phase or matrix. Adhesives in the form of an oil-in-water emulsion are especially preferred. Solvent based adhesives are preferably mixtures with water.

Pressure-sensitive adhesives form a bond by the application of light pressure when contacted with a substrate such as a palm tree surface. Both permanent and removable pressure-sensitive adhesives may be used. Pressure-sensitive adhesives are preferably in the form having a liquid carrier although pure, e.g., 100%, adhesives may also be used. Low viscosity polymers that are reacted with radiation to increase molecular weight and form the adhesive are especially preferred, as are high viscosity materials that are heated to reduce viscosity then cooled to final form. Pressure-sensitive adhesives include acrylate based polymers. Natural rubber and polychloroprene may be used as contact adhesives. After application it is preferred to allow pressure-sensitive adhesives to dry.

Hot melt adhesives in which the insecticide is already present may also be used. Application may be via glue gun. Hot adhesives, also known as hot melt adhesives, are thermoplastics applied in molten form (in the 65-180° C. range) which solidify on cooling to form strong bonds between a wide range of materials. Ethylene-vinyl acetate based hot-melts are particularly preferred.

Reactive adhesives including those having cross-linking components such as acrylics, urethanes, and epoxies may be used; including, polyester resin-polyurethane resin, polyol-polyurethane resin, and acrylic polymers-polyurethane resins.

Moisture curing adhesives such as cyanoacrylates and urethanes may also be used.

Examples include: cellulosic such as cellulose nitrate, cellulose acetate butyrate, methyl cellulose, ethyl cellulose; vinyls such as polyvinyl, polyvinyl alcohol, polyvinyl butyral, polyvinyl formal, polyvinyl chloride, polyvinyl ether may be used; acrylics in an emulsion or solvent soluble form, and reactive acrylic bases that differ from the standard acrylics such as second generation acrylics, anaerobic, cyanoacrylate.

Synthetic rubbers such as polyisoprene, polychloroprene, styrene (butadiene, styrene-diene-styrene), polyisobutylene, acrylonitrile-butadiene, polyurethane, polysulfide, silicone, aldehyde condensation resins, e.g., phenolics, resorcinol, and epoxide resins may be used as a major or minor component of the adhesive-containing composition. Polyamides, polyimide, polybenzimidazole, di-phthalates like, e.g., 3,3′-diaminobenzidine and di-phenylisophthalate, polyquinoxaline, polyethylenimine, polyester resin, dipolyalcohol and a polybasic acid reaction product, unsaturated polyolefin polymers, polyethylene, polypropylene, ethylene-vinyl acetate, ethylene-ethyl acrylate, and ionomers.

Commercially available polymer adhesives such as those available from Vinavil are preferred. Included are Vinavil vinyl acetate, modified vinyl acetate Vinavil®, Vinavil EVA®, Ravemul®, Raviflex®, Crilat® and Vinaflex® products lines including polymer types polyvinylacetate, vinylacetate/ethylene, vinylacetate/vinylversatate, vinylacetate/acrylate, vinylacetate/dibutylmaleate, acrylic, styrene/acrylic, vinylacetate/crotonic acid, e.g., VINAVIL CA/R, VINAVIL 2160 L, RAVEMUL 0 13, VINAVIL 2154 L, VINAVIL SA 55, VINAVIL SA, VINAVIL KA/R, RAVEMUL 0 16, VINAVIL 2150 H, RAVEMUL 0 15, RAVEMUL 0 17, VINAVIL 1150 L, VINAVIL 2140 H, VINAVIL 2560 M, VINAVIL 2257 M, VINAVIL 2252 M, VINAVIL 2251 L, VINAVIL 2253 M, VINAVIL 2254 M, VINAVIL 2255 M, VINAVIL 2258 M, RAVEMUL M 18, VINAVIL KM, RAVEMUL M 11, VINAVIL 2550 M, VINAVIL SK, RAVEMUL P 15, VINAVIL 2354 H, VINAVIL KA 25, RAVEMUL P 13, RAVEMUL P 18, VINAVIL MV 15 S, VINAVIL 2350 L, RAVEMUL P 18, VINAVIL 2335 L, VINAVIL EVA 015, VINAVIL EVA 203, VINAVIL EVA 204, VINAVIL EVA 201, VINAVIL EVA 202, VINAVIL EVA 2603 L, VINAVIL EVA 09, VINAVIL 2428, VINAVIL EVA 04, VINAVIL EVA 479 RS, VINAVIL EVA 1604, VINAVIL EVA 50-R, RAVEMUL T 33, RAVEMUL 0 23, VINAVIL 1438 L, VINAVIL HC, CRILAT 1815, CRILAT 2821, CRILAT 2816, VINAVIL 2415, CRILAT 2430, CRILAT 2951 L, CRILAT 2953 LHV, VINAVIL EVA 6615, VINAVIL 6915, VINAVIL F 30, VINAVIL SA 25, VINAVIL 4425, VINAVIL 4555, VINAVIL 03 V, VINAVIL 4528, RAVEMUL PC 2, RAVEMUL C 26, RAVEMUL T 33, RAVEMUL T 37, VINAVIL EVA 4612, VINAVIL EVA 04, CRILAT D 120 S, CRILAT 4724, CRILAT 4724 L, CRILAT 4732, CRILAT 4706, CRILAT 4710, CRILAT 4735, CRILAT 4720, CRILAT 4860, T 4816, CRILAT 4818, CRILAT D 117, CRILAT 4830, CRILAT 7829, CRILAT 4815, VINAVIL T 01, VINAVIL 5526, VINAVIL E 06, VINAVIL 5603 P, VINAVIL 5603 PB, VINAVIL SL 11 P, VINAVIL 5605 HP, VINAVIL 5415 HP, VINAVIL K 40, VINAVIL K 50, VINAVIL K 55, VINAVIL K 60, VINAVIL K 70, VINAVIL K 115, VINAFLEX CR 25, VINAFLEX CR 50, VINAFLEX CR 95, RAVIFLEX BL 1 S, RAVIFLEX BL 5 S, RAVIFLEX BL 6 S, and RAVIFLEX BL 7 S; VINAVIL 59 is especially preferred.

The insecticide-containing layer may contain one or more additional additives or components. For example, the insecticide-containing layer may contain a carrier, diluent and/or matrix fluid which may be either organic or inorganic. A preferred carrier is water although organic and naturally-occurring liquids such as limonene may also be used. Any naturally occurring organic solvent including, for example, natural oils may be used as an effective carrier for the application of an insecticide-containing composition that includes the insecticide and the polymeric adhesive in combination with other optional ingredient. Remnants and residues of the carrier or matrix may remain in the insecticide-containing layer formed after application of the insecticide-containing composition onto the surface of a palm plant.

The insecticide-containing layer and the insecticide-containing composition may contain one or more carriers or solvents. As used herein a “carrier” is a substance that transmits, serves, or aids in transmission or acts as the medium for transmission. Carriers may be liquid or solid. They are most often inert but may be active ingredients.

Formulations/compositions applied to a palm tree preferably contain amounts of a vinyl acetate polymer (alone or in combination with one or more other polymers) in weight ratios of polymer:insecticide:water of 10-60:0.001-10:10-80 based on the total weights of the polymer, the insecticide and water present in the composition applied to a palm tree surface. Preferably the relative amounts of polymer:insecticide:water are 20-50:0.01-5:20-50; and/or 30-50:0.1-1:30-50.

Representative formulations that may be applied to the exterior of a palm tree may contain, for example, Vinavyl 59 (40 g), 2% tefluthrin (14 g), and water (46 g). Other formulations may contain vinavyl 59 (43 g), zelig (7.5% chlorpyrifos) (7 g) and water (50 g), or also vinavyl 59 (49 g), zelig (7.5% chlorpyrifos) (1 g) and water (50 g).

Examples of conventional carrier vehicles and solvents include, but are not limited to, aerosol propellants which are gaseous at normal temperatures and pressures such as freon; inert dispersible liquid diluent carriers, including inert organic solvents, such as aromatic hydrocarbons (e.g., benzene, toluene, xylene, alkyl naphthalenes, etc.), halogenated especially chlorinated, aromatic hydrocarbons (e.g. chloro-benzenes, etc.), cycloalkanes, (e.g. cyclohexane, etc.), paraffins (e.g. petroleum or mineral oil fractions), chlorinated aliphatic hydrocarbons (e.g., methylene chloride, chloroethylenes, etc.), alcohols (e.g., methanol, ethanol, propanol, butanol, glycol, etc.) as well as ethers and esters thereof (e.g., glycol monomethyl ether, etc.), amines (e.g., ethanolamine, etc.), amides (e.g., dimethyl formamide etc.), sulfoxides (e.g., dimethyl sulfoxide, etc.), acetonitrile, ketones (e.g. acetone, methyl ethyl ketone, methyl isobutyl ketone, cyclohexanone, etc.), and/or water; as well as inert dispersible finely divided solid carriers such as ground natural minerals (e.g., vermiculite, alumina, silica, chalk, i.e. calcium carbonate, talc, attapulgite, montmorillonite, kieselguhr, etc.) and ground synthetic minerals (e.g. highly dispersed silicic acid, silicates, ego alkali silicates, etc.).

The insecticide-containing layer may further comprise one or more of a thickener, a surface-active agent, a preservative, an aromatic, a deodorizer, an antibacterial agent, an antifungal agent, an antimicrobial agent, a biocide agent, a sunscreen active agent or other adjuvant including, but not limited to, a wetting agent, a spreading agent, a sticking agent, a foam retardant, a buffer and an acidifier. The term “antibacterial agents” refers to substances which may destroy or inhibit the growth of bacteria; “antifungal agents” refers to substances which may destroy or inhibit the growth of fungi; “antimicrobial agents” refers to substance which may kill or inhibit the growth of microorganisms and “biocide agents” refers to chemical substances or microorganisms which may be capable of destroying living organisms

The insecticide-containing layer may further comprise one or more synthetic or naturally derived repellants. The term “repellent” is used herein to describe a composition or component of a composition that functions to make unattractive or repel a pest such as an insect. Repellants may include, for example, essential plant and herb oils where an “essential oil” is any hydrophobic liquid containing volatile aromatic compounds from plants extracted by distillation or solvent extract and a “herb oil” refers to any of the oils derived from herbs, e.g., a plant lacking a permanent woody stem and include mint and geranium oils. Essential oils may include eucalyptus oil, castor oil, mint oil, jasmine oil, camphor oil, hinoki oil, tohi oil, pomegranate oil, turpentine oil, cinnamon oil, bergamot oil, mandarin oil, calamus oil, pine oil, lavender oil, bay oil, clove oil, hiba oil, rose oil, lemon oil, thyme oil, peppermint oil, rose oil, sage oil, menthol, cineole, eugenol, citral, citronellal, borneol, linalool, geraniol, camphor, thymol, spilanthole, pinene, limonene, and terpene compounds. The repellant may also function as a carrier or solvent during the process of applying the insecticide-containing layer onto a palm tree surface.

Other repellants include milk, bitrex, thiram, methyl ammonium saccharide, thymol, garlic, garlic powder, garlic oil, capsaicin, hot pepper, white pepper, oil of black pepper, piperine, chemically formulated pepper, urea, naphthalene (moth balls), pyrethrine, blood, blood meal, bone meal, sulfurous emitting items (eggs, sulfur, meats, etc), denatonium benzoate, ammonium of fatty acids, butyl mercaptan, clove, fish oil, onion, ammonia, mineral oil, orange oil, kelp (seaweed), whole eggs, powdered eggs, putrescent eggs, egg whites, egg yolks, rotten eggs, rosemary, wintergreen, 2-propenoic acid, potassium salt, 2-propeniamide, 2-phenethyl propionate, acetic acid, latex, animal glue, clay, formaldehyde, and thyme.

The repellent is preferably distributed homogeneously in a polymer adhesive matrix forming the insecticide-containing layer. In circumstances where the repellent is a volatile oil some transfer of repellent out of the insecticide-containing layer and away from the palm tree into the environment may occur and likewise some transfer of repellent from the insecticide-containing layer into the palm tree may occur. However, the insecticide remains immobilized in the insecticide-containing layer and does not enter the vascular system of the palm tree.

The repellent may be present in the insecticide-containing layer in amounts substantially greater than the insecticide. For example, a repellent such as Camphor oil may be present in the insecticide-containing layer in an amount equal to the amount of the polymer adhesive. For example, an insecticide-containing layer may contain equivalent amounts of a polymer adhesive and a repellent in addition to relatively lesser amounts of an insecticide. Preferably a repellent is present in an amount of from 0.01 to 50% by weight based on the total weight of the insecticide-containing layer present on a palm tree surface. Preferably the repellent is present in an amount of 0.5-50% by weight, 1.0-30% by weight, 5%-25% by weight, 10%-25% by weight and preferably about 15% by weight. Additional and/or other additives described herein may be present in an amount equivalent to or any fraction or multiple ranging from 0.1 to 10 times, preferably 0.5-5 or 1.0 times the amount of any amount of the insecticide, repellent or other component described herein.

The addition of cedar oil to the composition enhances the effectiveness of the insecticide-containing layer as a repellent. It also adds ability to repel insects and kill mosquito larvae in water. Cedar oil may be added at between 0.03% and 10%. It may be added between 1% and 5%, between 2% and 4% or between 5% and 10%.

Camphor is a waxy, white or transparent solid with a strong, aromatic odor. It is a terpenoid with the chemical formula C₁₀H₁₆O. It is found in wood of the camphor laurel (Cinnamomum camphora), a large evergreen tree found in Asia (particularly in Borneo and Taiwan). It also occurs in some other related trees in the laurel family, notably Ocotea usambarensis. Camphor has been used as an insect repellent and may be added to the insecticide-containing layer in amounts of (by weight percent) of from 0.01% to 15%. It may be added between 1% and 5%, between 2% and 4% or between 5% and 10%.

Pyrithrin is a natural insecticide sometimes characterized as a repellant. Pyrethrins are natural organic compounds that have potent insecticidal activity. Pyrethrin I and pyrethrin II are structurally related esters with a cyclopropane core. They differ by the oxidation state of one carbon and exist as viscous liquids. The pyrethrins are contained in the seed cases of the perennial plant pyrethrum (Chrysanthemum cinerariaefolium), which is grown commercially to supply the insecticide.

When present in amounts not fatal to insects, pyrithrins have an insect repellent effect. They are harmful to fish, but are far less toxic to mammals and birds than many synthetic insecticides. Pyrithrins are non-persistent, biodegradable, break down easily on exposure to light or oxygen and are considered to be among the safest insecticides for use around food. Pyrithrins may be present in the insecticide-containing layer at between 0.001 wt. % and 10 wt. %, or from 1% and 5%, between 2% and 4% or between 5% and 10 wt. %.

The insecticide-containing layer and the insecticide-containing composition may be mixtures with finely divided solids such as talc, attapulgite clay, kieselguhr, pyrophyllite, chalk, diatomaceous earth, vermiculite, calcium phosphates, calcium and magnesium carbonates, sulfur, flours, and other organic and inorganic solids which act as carriers. These finely divided solids, or dusts, preferably have an average particle size of less than about 50 microns. A typical dust formulation useful for controlling pests contains 1 part of insecticide-containing composition and 99 parts of diatomaceous earth or vermiculite. Granules may comprise porous or nonporous particles. The granule particles are relatively large, a diameter of about 400-2500 microns typically. The particles are either impregnated or coated with the inventive repellent compositions from solution. Thus, the insecticide-containing layer and the insecticide-containing composition can be formulated with any of the following solid carriers or diluents such as bentonite, fullers earth, ground natural minerals, such as kaolins, clays, talc, chalk, quartz, attapulgite, montmorillonite or diatomaceous earth, vermiculite, and ground synthetic minerals, such as highly-dispersed silicic acid, alumina and silicates, crushed and fractionated natural rocks such as calcite, marble, pumice, sepiolite and dolomite, as well as synthetic granules of inorganic and organic meals, and granules of organic materials such as sawdust, coconut shells, corn cobs, tobacco stalks and other natural cast off products that may or may not be a by-product of manufacturing or harvest such as walnut or nut shells or egg shells.

One or more thickeners or thickening agents may be present in the insecticide-containing layer and the insecticide-containing composition. A “thickener” is a substance which, when added to a mixture (aqueous or otherwise), increases its viscosity without substantially modifying its other properties. Thickeners may be used to ensure uniform consistency. A starch, thickener, or gelling agent may also be used to alter the consistence of the repellent compositions of the present invention. Agar, corn starch, potato starch and guar gum or the like, may be used. These agents can also be added to keep the ingredients in suspension. Typically thickeners are added at about 0.1 to 5% of the total composition.

Preservatives may be present in the insecticide-containing layer and the insecticide-containing composition. As used herein a “preservative” is any substance or compound that is added to protect against decay, decomposition or spoilage. Means of preservation may also be utilized. Preservatives may be natural or synthetic. They may be antimicrobial preservatives, which inhibit the growth of bacteria or fungi, including mold, or antioxidants such as oxygen absorbers, which inhibit the oxidation of food constituents. Common antimicrobial preservatives include calcium propionate, sodium nitrate, sodium nitrite, sulfites (sulfur dioxide, sodium bisulfite, potassium hydrogen sulfite, etc.) and disodium EDTA. Antioxidants include BHA and BHT.

Other preservatives include formaldehyde (usually in solution), glutaraldehyde (kills insects), ethanol and methylchloroisothiazolinone. A preservative, such as potassium sorbate can be added to the compositions or formulations. Typically, preservatives appear in the compositions at between 0.03 to 3% by weight percent.

Optional components such as one or more dilute acids, other naturally occurring insecticides, sodium chloride and potassium soaps increase the range of activity of the base repellent composition with regard to the number of animal species repelled and the duration of the repulsive effect. Therefore, these may be added in suitable weight percent amounts. Other possible additives are perfumes, mineral or vegetable, optionally modified oils, waxes and nutrients (including trace nutrients), such as salts of iron, manganese, boron, copper, cobalt, molybdenum and zinc.

It may also be advantageous to include one or more surface active agents in the insecticide-containing layer and/or the insecticide-containing composition. Surface-active agents, (i.e., conventional carrier vehicle assistants) that may be employed with the present invention include, without limitation, emulsifying agents, such as non-ionic and/or anionic emulsifying agents (e.g. polyethylene oxide esters of fatty acids, polyethylene oxide ethers of fatty alcohols, alkyl sulfates, alkyl sulfonates, aryl sulfonates, albumin hydrolyzates, and especially alkyl arylpolyglycol ethers, magnesium stearate, sodium oleate, etc.); and/or dispersing agents such as lignin, sulfite waste liquors, methyl cellulose, etc.

When the insecticide-containing composition is applied to a palm tree surface it must be able to wet the surface and spread out or cover an sufficient area to perform its intended insecticidal function. In some situations, a wetting agent (also known as a spreading agent or surfactant) is advantageous for good coverage. A wetting agent/surfactant reduces the surface tension of the water on the surface of the spray drop and by reducing the interfacial tension between the spray drop and surface. This requires a surfactant that will preferentially aggregate at these surfaces. Surfactants wet and disperse particles of active ingredient(s) in the concentrate or upon dilution prior to application, and wet the palm tree surface with the insecticide-containing composition to achieve more effective coverage. Concentrated multipurpose wetting agents typically contain a blend of bio-degradable, non-ionic surfactants and an emulsified silicone type antifoam preparation. This action provides uniform wetting and coverage. Exemplary surfactants include amphoteric zwitterionic surfactants; anionic surfactants; nonionic surfactants; cationic surfactants. Surfactants can be described as a surface active agent containing at least one anionic and one cationic group and can act as either acids or bases depending on pH. Some of these compounds are aliphatic derivatives of heterocyclic secondary and tertiary amines in which the aliphatic radical may be straight or branched and wherein one of the aliphatic substituents contains from about 6 to about 20, preferably 8 to 18, carbon atoms and at least one contains an anionic water-solubilizing group, e.g., carboxy, phosphonate, phosphate, sulfonate, sulfate.

Zwitterionic surfactants are surface active agents having a positive and negative charge in the same molecule which molecule is zwitterionic at all pH's. Zwitterionic surfactants are illustrated by betaines and sultaines. The zwitterionic compounds generally contain a quaternary ammonium, quaternary phosphonium or a tertiary sulfonium moiety. In all of these compounds there is at least one aliphatic group, straight chain or branched, containing from about 6 to 20, preferably 8 to 18, carbon atoms and at least one aliphatic substituent containing an anionic water-solubilizing group, e.g., carboxy, sulfonate, sulfate, phosphate or phosphonate. Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl mono acetate, alkyl diacetates, alkyl amphoglycinates, and alkyl amphopropionates wherein alkyl represents an alkyl group having from 6 to about 20 carbon atoms. Other suitable surfactants include alkyliminomonoacetates, alkyliminidiacetates, alkyliminopropionates, alkyliminidipropionates, and alkylamphopropylsulfonates having between 12 and 18 carbon atoms, alkyl betaines and alkylamidoalkylene betaines and alklyl sultaines and alkylamidoalkylenehydroxy sulfonates. Anionic surfactants which may be used in the present invention are those surfactant compounds which contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants.

Anionic surfactants include the alkali metal, ammonium and alkanol ammonium salts of organic sulfuric reaction products having in their molecular structure an alkyl, or alkaryl group containing from 8 to 22 carbon atoms and a sulfonic or sulfuric acid ester group. Examples of such anionic surfactants include water soluble salts and mixtures of salts of alkyl benzene sulfonates having between 8 and 22 carbon atoms in the allyl group, alkyl ether sulfates having between about 8 and about 22 carbon atoms in the alkyl group and about 2 to about 9 moles ethylene oxide in the ether group. Other anionic surfactants that can be mentioned include alkyl sulfosuccinates, alkyl ether sulfosuccinates, olefin sulfonates, alkyl sarcosinates, alkyl mono glyceride sulfates and ether sulfates, alkyl ether carboxylates, paraffinic sulfonates, mono and dialkyl phosphate esters and ethoxylated derivatives, acyl methyl taurates, fatty acid soaps, collagen hydrosylate derivatives, sulfoacetates, acyl lactates, aryloxide disulfonates, sulfosuccinamides, naphthalene-formaldehyde condensates and the like. Aryl groups generally include one and two rings, alkyl generally includes from 8 to 22 carbon atoms and the ether groups generally range from 1 to 9 moles of ethylene oxide (EO) and/or propylene oxide (PO), preferably EO. Specific anionic surfactants which may be selected include linear alkyl benzene sulfonates such as decylbenzene sulfonate, undecylbenzene sulfonate, dodecylbenzene sulfonate, tridecylbenzene sulfonate, nonylbenzene sulfate and the sodium, potassium, ammonium, triethanol ammonium and isopropyl ammonium salts thereof.

The nonionic surfactant(s) may be any of the known nonionic surfactants which are generally selected on the basis of compatibility, effectiveness and economy. Examples of useful nonionic surfactants include condensates of ethylene oxide with a hydrophobic moiety. The surfactants include the ethoxylated primary or secondary aliphatic alcohols having from about 8 to about 24 carbon atoms, in either straight or branch chain configuration, with from about 2 to about 40, and preferably between about 2 and about 9 moles of ethylene oxide per mole of alcohol. Other suitable nonionic surfactants include the condensation products of from about 6 to about 12 carbon atoms alkyl phenols with about 3 to about 30, and preferably between about 5 to about 14 moles of ethylene oxide. Many cationic surfactants are known in the art and almost any cationic surfactant having at least one long chain allyl group of about 10 to 24 carbon atoms is suitable for optional use in the present invention.

Some formulations will create foam in spray tanks as a result of both the surfactants used in the concentrate formulation and the type of spray tank agitation. This foam can be reduced or eliminated by a small amount of foam inhibitor.

Oil based defoamers have an oil carrier. The oil might be mineral oil, vegetable oil, white oil or any other oil that is insoluble in the foaming medium, except silicone oil. An oil based defoamer also contains a wax and/or hydrophobic silica to boost the performance. Typical waxes are ethylene bis stearamide (EBS), paraffinic waxes, ester waxes and fatty alcohol waxes. These products might also have surfactants to improve emulsification and spreading in the foaming medium.

Water based defoamers are different types of oils and waxes dispersed in a water base. The oils are often white oils or vegetable oils and the waxes are long chain fatty alcohol, fatty acid soaps or esters. These are normally best as deaerators, which mean they are best at releasing entrained air.

Silicone-based defoamers have a silicone compound as the active component. These may be delivered as oil or a water based emulsion. The silicone compound consists of a hydrophobic silica dispersed in a silicone oil. Emulsifiers are added to ensure that the silicone spreads fast and well in the foaming medium. The silicone compound might also contain silicone glycols and other modified silicone fluids.

EO/PO based defoamers contain polyethylene glycol and polypropylene glycol copolymers. They are delivered as oils, water solutions, or water based emulsions. EO/PO copolymers normally have good dispersing properties and are often well suited when deposit problems are an issue.

Alkyl polyacrylates may be suitable for use as defoamers in non-aqueous systems where air release is more important than the breakdown of surface foam. These defoamers are often delivered in a solvent carrier like petroleum distillates.

Foam retardants or defoamers may be used in the insecticide-containing compositions in amounts of from 0.5% to 10% by weight.

Some water used for diluting formulations is alkaline (high pH). If the pH is sufficiently high and the insecticide-containing composition is subject to degradation by alkaline hydrolysis, it may be necessary to lower the pH of the mix water to a pH in the range of 3 to 7, preferably 3.75 to 4.25. Buffers containing phosphoric acid or a salt of phosphoric acid, will lower the pH of the water and tend to stabilize the pH at an acceptable value. The efficacy of the buffer depends on its concentration of phosphoric acid and the degree of alkalinity or “hardness” of the mixing water that is being neutralized. The more alkaline the water, the greater the amount of buffer required.

Some buffers have sufficient surfactant present to also perform as wetter-spreaders. The concentration of surfactant and phosphoric acid are usually lumped together and it is not possible to determine the concentration of either and thus predict their efficacy. A useful range for phosphoric acid buffer concentration is from about 2 to 10%.

Buffers that acidify alkaline spray waters may also increase the effectiveness. Buffers can help increase the residual life of the formulation and can result in reducing the number of applications. Muriatic acid, Buffer-X or vinegar may be effective for this purpose. The duration and scope of effectiveness of the present invention may also be increased by adding a dilute acid to the composition, especially acetic acid, which may be in the form of vinegar, preferably white distilled vinegar having an acid content of between 3.5 and 5% acetic acid.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc. Colorants are advantageous when it is important for the insecticide-containing compositions when applied to blend in, or be less detectable in the environment applied. This advantage is sometimes aesthetic but can serve a functional role where pests are likely to either be attracted or repelled based on color.

The insecticide-containing composition is made by concurrently or separately mixing a plurality of ingredients prior to application of the insecticide-containing composition to a palm plant. An insecticide-containing composition that includes a vinyl acetate polymer, insecticide and an aqueous carrier can be prepared by mixing the ingredients in any order. For example, the polymer adhesive maybe first mixed with the water by adding the polymer adhesive to the water or by adding the water to the polymer adhesive. The resulting composition is generally a dispersion or suspension of the polymer adhesive in water and maybe either in the form of a water-in-oil emulsion or an oil-in-water emulsion. Insecticides may be added to either the water or the polymer adhesive prior to mixing the polymer adhesive with water. Preferably the insecticide is mixed with the phase containing the aqueous or organic solvent or polymer adhesive phase that is most compatible with the insecticide. Alternately, the insecticide may be added to a mixture that already comprises a dispersion or suspension of polymer adhesive in water. Any number of additives may be added either to the water phase or the organic phase prior to, concurrent with, or after mixing the water and organic phases.

Typically the water is present in an amount of from 5-95% by weight based on the total weight of the insecticide-containing composition. Preferably the water is present in an amount of 10-90% by weight, 15-85% by weight, 20-80% by weight, 25-75% by weight, 30-70% by weight, 35-65% by weight, 40-60% by weigh, 45-55% by weight or about 50% by weight.

When used as an organic base in which an insecticide is dispersed, suspended or dissolved in an organic medium such as organic solvent, the organic solvent is present in an amount of from 5-95% by weight based on the total weight of the insecticide-containing composition. Preferably the organic phase (e.g., an organic solvent such as limonene) is present in an amount of 10-90% by weight, 15-85% by weight, 20-80% by weight, 25-75% by weight, 30-70% by weight, 35-65% by weight, 40-60% by weight, 45-55% by weight, 50-55% or about 50% by weight based on the total weight of the insecticide-containing composition.

The insecticide layer may be applied by any suitable method that is effective for depositing a continuous or semi-continuous insecticide layer on one or more surfaces of the palm tree and that provides an insecticidally effective layer on the surface of the palm tree surface. Methods of applying an insecticide composition to a palm tree surface to form an insecticide-containing layer include: painting, brushing, mopping, spreading, banding, broadcasting, side-dressing, coating, rolling, bathing, dipping, immersing, soaking, adhering, sticking, rubbing, wiping, impregnating, injecting, embedding, sealing, stippling, dotting, dabbing, stenciling, stamping, layering, spackling, sprinkling, aerosolizing, misting, dusting, fumigation, aerial application, vaporizing, pouring and combinations thereof. Aerial application includes, but is not limited to, distribution from an aircraft or object that is not tethered to the ground.

In a preferable method the insecticide layer is applied by spraying a liquid insecticide-containing composition on a palm tree including the surface of the trunk, the surface of the leaves and, optionally, immediately on the ground surrounding or covering the ground in which the palm tree roots are growing.

The composition which is applied to the surface of the palm tree may contain a polymeric adhesive or contain components of a polymeric adhesive which polymerize when deposited on the surface of the palm tree to form the insecticide-containing layer. In one embodiment of the invention the polymeric adhesive is a polyvinyl acetate that is soluble in water and/or an organic carrier such as limonene. Upon application of an insecticide-containing composition to a palm tree and subsequent evaporation of carrier material, the polymeric adhesive remains as a residue in which the insecticide is homogeneously dispersed. The same technique may be used for applying an adhesive-containing composition to a palm tree surface or a polymeric precursor-containing composition to a palm tree surface whereby the precursor is subsequently or concurrently subject to polymerization, e.g., spraying, aerially and/or painting.

In another embodiment, an insecticide-containing composition may include an insecticide, a carrier or solvent, a monomer and, optionally, a polymerization agent or initiator. Initially when the insecticide-containing composition is applied to a palm tree the polymer has not yet formed or the polymeric precursor is in the process of undergoing polymerization to form the polymeric adhesive.

Preferably, the insecticide-containing composition is applied to a palm trunk in an amount of about 0.5 kg/palm tree for palm trees having an average diameter of about 60 cm and a trunk height of about 3.5 m. Of course, the insecticide-containing composition may be present in a greater amount, e.g., as much as 5 kg/palm tree. In other embodiments the amount of insecticide-containing composition that is applied to the Palm trunk may be as little as 0.05 kg/palm tree but it's preferably in the range of 0.25-2 kg/palm tree. Similar amounts of the insecticide containing composition may be applied to the trunk of a palm tree when the insecticide-containing composition is based on an organic solvent or carrier rather than an aqueous matrix.

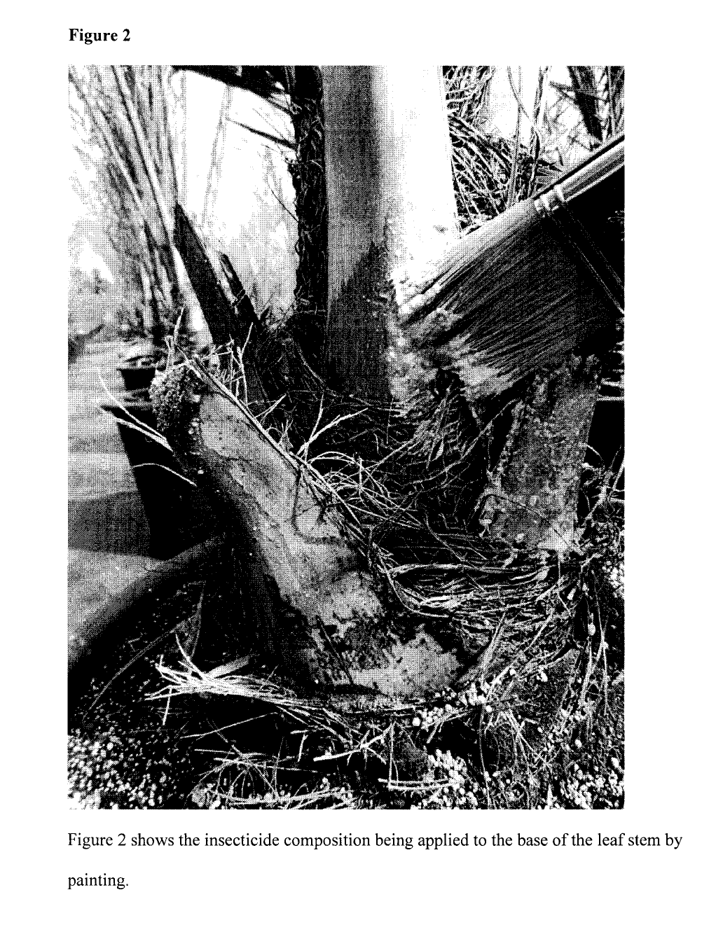

FIG. 2 shows the insecticide-containing composition being applied at a leaf base and/or base of a leaf petiole of a palm leaf of a palm tree trunk. In FIG. 2 the insecticide-containing composition is applied by brushing on areas of the leaf base closest to the palm tree trunk. Full coverage of the surfaces of the palm leaf at the leaf base and/or at the base of the leaf petiole ensures resistance against attack by the red palm weevil.

During seasons of the year or during seasons of the reproductive cycle of the red palm weevil when the red palm weevil is particularly active and laying eggs to a particular of a palm tree, the insecticide layer may be selectively applied to the surface of the palm tree which is most susceptible to attack or infestation by the red palm weevil. For example, the insecticide layer may be selectively applied only to the trunk and not to the leaves of the palm tree during times of the year or during seasons of the red palm weevil reproductive cycle during which the red palm weevil is actively laying eggs mainly on the trunk of a palm tree. During other seasons or times of the year where red palm weevil activity may be concentrated in the leaf and crown area of a palm tree the insecticide layer may be selectively applied to the palm leaves or root initiation zone without or with minor application to the other surfaces of the palm tree. During times when red palm weevil activity and egg laying is concentrated in the crown of the palm tree the insecticide layer may be applied aerially such that the leaf surfaces of a large number of palm trees, for example in a palm tree orchard, are treated at the same time.

In a preferable embodiment of the invention an insecticide-containing layer is applied to a surface of a palm tree at an interval/frequency of no shorter than 3 months. Preferably the insecticide-containing layer is applied to the surface of the palm tree no more than once every 6 months, 8 months, 10 months, or once per year during which a single application of the insecticide-containing layer is effective at preventing red palm weevil infestation and/or treating red palm weevil infestation for at least 3 months without application of any other insecticide or treating agent targeted at the red palm weevil.

Within the intervals of treatment the palm tree may be treated with one or more other insecticides that are effective for treating or prevent infestations of other pests besides the red palm weevil but are otherwise not targeted at the red palm weevil. For example, a palm tree may be treated with an insecticide-coating layer as described herein and, within a period of less than 3 months, treated with one or more other insecticides that enter the palm tree vascular system. An example of such treatment includes, for example, first applying an insecticide-coating layer to a palm tree to treat or prevent infestation by the red palm weevil then, within a period of from 1 day to 3 months treating the same palm tree with a neonicotinoid insecticide for treating, for example, nematode worms or other sucking or chewing insects present either in the soil or in the environment surrounding the palm tree. Such neonicotinoid pesticides may include imidacoloprid, thiamethoxam, clothianidin, acetamiprid, thiacloprid, dinotefuran, sulfoxaflor or nitenpyram.

While it is acceptable for the secondary pesticides such as the neonicotinoid to enter and function in the vascular system of the palm tree, the primary mode of red palm weevil control and lethality is the insecticide-containing layer present on the exterior surface of the palm tree which serves to deliver a lethal dose of insecticide to the red palm weevil or red palm weevil larvae as it boars into or through an exterior surface of the palm tree. Any secondary insecticide used to treat the palm tree within a 3 month or 6 month treatment period after application of the insecticide-coating layer to the palm tree preferably includes only pesticides other than pesticides present in the pesticide-containing layer.

The insecticide-containing composition that is applied to a palm tree to form the insecticide-containing layer may be in the form of an aqueous solution, an aqueous suspension, an aqueous slurry, a solution in an organic solvent, a suspension in an organic solvent, oil-in-water emulsion, or a water-in-oil emulsion.

As used herein the term “aqueous” means similar to or containing or dissolved in water, e.g., an aqueous solution. A “slurry” is a suspension of predominantly insoluble particles, usually in water. Formulations may also be in the form of solid mixtures, whether in bulk, small particulate or dust form. Particulates may be homogenous or heterogeneous. They may be granules or particles, organic or inorganic.

The oil-in-water emulsion has an oil phase and a water phase, the oil-in-water emulsion composition comprising an oil or organic otherwise non-aqueous medium adapted to form oily globules having a mean particle diameter of less than about 1 mm. A vegetable based oil that has very low water solubility, and is compatible with the insecticide of the oil phase is preferred. In addition at least one ionic or non-ionic lipophilic surface-active agent may be present, alone or in combination with one or more surfactants or surface active agents. The water-in-oil emulsion includes an organic phase acting as a matrix in which droplets of an aqueous phase are dispersed. The aqueous droplets preferably have mean particle diameter of less than about 1 mm.

The oil phases of the oil-in-water or water-in-oil emulsions contain an organic liquid that is not miscible with water. Any oil which is compatible with the insecticide may be used in the emulsions. The term ‘compatible’ means that the oil will dissolve or mix uniformly with the insecticide and allow for the formation of the oily globules of the oil-in-water emulsion or the formation of an oil phase/matrix in the water-in-oil emulsion.

Exemplary oils include, but are not limited to short-chain fatty acid triglycerides, silicone oils, petroleum fractions or hydrocarbons such as heavy aromatic naphtha solvents, light aromatic naphtha solvents, hydrotreated light petroleum distillates, paraffinic solvents, mineral oil, alkylbenzenes, paraffinic oils, and the like; vegetable oils such as soy oil, rape seed oil, coconut oil, cotton seed oil, palm oil, soybean oil, and the like; alkylated vegetable oils and alkyl esters of fatty acids such as methyloleate, the organic solvents otherwise disclosed herein, and the like.

The insecticide-containing compositions that are used to form the insecticide-containing layer may contain carrier vehicle assistants, e.g. conventional surface-active agents, including emulsifying agents and/or dispersing agents. Further, in the case where water is used as diluent, organic solvents may be added as auxiliary solvents. Suitable liquid diluents or carriers include water, petroleum distillates, or other liquid carriers with or without surface active agents. The choice of dispersing and emulsifying agents and the amount employed is dictated by the nature of the components of the insecticide-containing layer and the ability of the agent to facilitate advantageous deposition and layer formation. Non-ionic, anionic, amphoteric, or cationic dispersing and emulsifying agents may be included.

### EXAMPLES

The following examples are presented for illustrative purposes only. The scope of the invention is not limited to these examples. Experiments were performed to test the efficacy of the inventive coating composition and method. Experiments were first performed on palm trees in greenhouses (in Turin) to evaluate phytotoxicity, then on nursery palm trees in the field (in Sicily) to evaluate efficacy of preventing red palm weevil infestation.

### Greenhouse Experiments

Twelve different experimental combinations of polymeric adhesive, insecticide, and repellent were tested, along with a negative control, to evaluate phytotoxicity. The 13 tested treatment conditions are shown in Table 1.

Treatment conditions T1-T6 used vinyl acetate as the polymeric adhesive, and water as the solvent. T2 and T3 used tefluthrin as the insecticide in differing amounts, and T5 and T6 used chlorpyrifos as the insecticide in differing amounts. T1-T3, T5 and T6 additionally used camphor white oil as a repellent. T1 and T4 used no insecticide, and T4 used no repellent.

Treatment conditions T7-T12 used raw linseed oil as the polymeric adhesive, and limonene as the solvent. T7 and T8 used tefluthrin as the insecticide in differing amounts, and T9 and T10 used chlorpyrifos as the insecticide in differing amounts. T7-T10, and T12 additionally used camphor white oil as a repellent. T11 and T12 used no insecticide, and T11 used no repellent.

Negative control treatment condition 13 used no polymeric adhesive, no insecticide, and no repellent.

For treatment conditions T1-T12, the respective compositions were applied to the trees by painting.

TABLE 1

| Treatment | Adhesive | Solvent | Insecticide | Repellent |
|---|---|---|---|---|
| T1 | Vinyl acetate 59 | 38.7 g | | 5 g Camphor |
| | (100 g) | H2O | | White oil |
| T2 | Vinyl acetate 59 | 109.3 g | 40 g Teflustar | 5 g Camphor |
| | (100 g) | H2O | (0.08 g | White oil |
| | | | tefluthrin) | |
| T3 | Vinyl acetate 59 | 109.3 g | 20 g Teflustar | 5 g Camphor |
| | (100 g) | H2O | (0.04 g | White oil |
| | | | tefluthrin) | |
| T4 | Vinyl acetate 59 | 38.7 g | | |
| | (100 g) | H2O | | |
| T5 | Vinyl acetate 59 | 82.7 g | 30 g Zelig GR | 5 g Camphor |
| | (100 g) | H2O | (2.25 g | White oil |
| | | | chlorpyrifos) | |
| T6 | Vinyl acetate 59 | 46.7 g | 15 g Zelig GR | 5 g Camphor |
| | (100 g) | H2O | (1.125 g | White oil |
| | | | chlorpyrifos) | |
| T7 | Raw Linseed oil | 25 g | 40 g Teflustar | 5 g Camphor |
| | (100 g) | Limonene | | White oil |
| T8 | Raw Linseed oil | 25 g | 20 g Teflustar | 5 g Camphor |
| | (100 g) | Limonene | | White oil |
| T9 | Raw Linseed oil | 25 g | 30 g Zelig GR | 5 g Camphor |
| | (100 g) | Limonene | | White oil |
| T10 | Raw Linseed oil | 25 g | 15 g Zelig GR | 5 g Camphor |
| | (100 g) | Limonene | | White oil |
| T11 | Raw Linseed oil | 25 g | | |
| | (100 g) | Limonene | | |
| T12 | Raw Linseed oil | 25 g | | 5 g Camphor |
| | (100 g) | Limonene | | White oil |

| | |
|---|---|
| 13 | No treatment (negative control) |

The 13 treatment conditions were tested on two species of palm, the date palm Phoenix dactylifera and the canary palm Phoenix canariensis, to evaluate phytotoxicity. A total of 260 potted palms were evaluated in the greenhouse experiments (130 P. dactylifera and 130 P. canariensis).

Phytotoxicity was evaluated by a monthly visual assessment observing the presence or absence of leaf discoloration, necrosis and tissue deformation. In addition to the visual assessment, other measurements were performed, including thickness measurements of the films applied (three measurements per leaf on three leaves on a coated portion of each plant) (November, December, January and February) (Tables 3-6) and indirect measurements of chlorophyll content (November, December, January and February) (Tables 5 and 6). A summary of greenhouse activities is shown in Table 2.

TABLE 2

| | August | September | October | November | December | January | February |
|---|---|---|---|---|---|---|---|
| Treatments | X | | | | | | |
| (12 for each | | | | | | | |
| species) | | | | | | | |
| CCI | X | X | X | X | X | X | X |
| (Chlorophyll | (immediately | | | | | | |
| Content | before | | | | | | |
| Index) | treatment) | | | | | | |
| Thickness of | | | X | X | X | X | X |
| film applied | | | | | | | |
| Visual | | | X | X | X | X | X |
| assessment | | | | | | | |

Temperature and humidity conditions in the greenhouse environment were constantly measured by a data logger during the entire period.

The stability of insecticide coating compositions on the plants was evaluated by measuring the thickness of the coating film. After six months the film thickness was about 0.250 mm for vinyl acetate treatment conditions (T1 to T6; Tables 3 and 5) and 0.09 mm for raw linseed oil treatment conditions (T7 to T12; Tables 4 and 6). It was found that vinyl acetate did not have a homogeneous thickness on all surfaces treated, likely because application was done by hand.

Table 3 shows average thickness values of coating films for each vinyl acetate treatment condition on P. dactylifera in the greenhouse experiments. No significant differences were observed based on an analysis of variance test (ANOVA p≦0.05).

TABLE 3

| Treatment | Average Thickness (μm) |
|---|---|
| T1 | 231.2 ± 48.1a |
| T2 | 247.4 ± 45.2a |
| T3 | 246.0 ± 37.4a |
| T4 | 225.9 ± 73.6a |
| T5 | 271.7 ± 51.2a |
| T6 | 238.4 ± 43.4a |

Table 4 shows average thickness values of coating films for each raw linseed oil treatment condition on P. dactylifera in the greenhouse experiments. No significant differences were observed (ANOVA p≦0.05).

TABLE 4

| Treatment | Average Thickness (μm) |
|---|---|
| T7 | 90.1 ± 7.2a |
| T8 | 81.2 ± 16a |
| T9 | 94.2 ± 17.2a |
| T10 | 91.8 ± 28.5a |
| T11 | 84.9 ± 7.7a |
| T12 | 78.9 ± 9.6a |

Table 5 shows average thickness values of coating films for each vinyl acetate treatment condition on P. canariensis in the greenhouse experiments. No significant differences were observed (ANOVA p≦0.05).

TABLE 5

| Treatment | Average Thickness (μm) |
|---|---|
| T1 | 230.1 ± 37.4a |
| T2 | 257.2 ± 39.7a |
| T3 | 250.6 ± 45.7a |
| T4 | 247.2 ± 50.8a |
| T5 | 244.6 ± 51.9a |
| T6 | 237.8 ± 45.7a |

Table 6 shows average thickness values of coating films for each raw linseed oil treatment condition on P. canariensis in the greenhouse experiments. No significant differences were observed (ANOVA p≦0.05).

TABLE 6

| Treatment | Average Thickness (μm) |
|---|---|
| T7 | 89.4 ± 18.5a |
| T8 | 94.8 ± 18.4a |
| T9 | 92.3 ± 22.2a |
| T10 | 84.6 ± 19.8a |
| T11 | 81.1 ± 27.1a |
| T12 | 77.6 ± 18.2a |

At the end of August, no potted palm trees exhibited damage. Six months later, in February, damage was similarly absent. As shown in Tables 7-10 below, no phytotoxic effects were observed on the potted greenhouse palms at the end of six months. For each treatment condition and for each damage parameter (chlorophyll content index, discoloration, and necrosis) no significant differences were observed among the four months examined (months 3-6 after treatment).

Table 7 shows average values of the three damage parameters for P. dactylifera under each vinyl acetate treatment condition (T1-T6) as well as the no-treatment control (13). No significant differences were observed (ANOVA p≦0.05).

Table 8 shows average values of the three damage parameters for P. dactylifera under each raw linseed oil treatment condition (T7-T12) as well as the no-treatment control (13). No significant differences were observed (ANOVA p≦0.05).

Table 9 shows average values of the three damage parameters for P. canariensis under each vinyl acetate treatment condition (T1-T6) as well as the no-treatment control (13). No significant differences were observed (ANOVA p≦0.05).

Table 10 shows average values of the three damage parameters for P. canariensis under each raw linseed oil treatment condition (T7-T12) as well as the no-treatment control (13). No significant differences were observed (ANOVA p≦0.05).

The greenhouse experiments established that treatment conditions T1-T12 were not phytotoxic to P. dactylifera or P. canariensis.

TABLE 7

| | CCI | | | | Discoloration* | |
|---|---|---|---|---|---|---|
| Treatment | November | December | January | February | November | December |
| T1 | 53.6 ± 14.2 | 53.2 ± 13.9 | 52.1 ± 13.8 | 51.7 ± 13.5 | 0.2 ± 0.4 | 0.2 ± 0.4 |
| T2 | 51.3 ± 11.6 | 50.9 ± 11.5 | 50.4 ± 11.4 | 50.6 ± 11.1 | 0.1 ± 0.3 | 0.1 ± 0.3 |
| T3 | 44.8 ± 9.9 | 44.3 ± 9.4 | 44.3 ± 9.4 | 44.4 ± 9.4 | 0.3 ± 0.5 | 0.3 ± 0.5 |
| T4 | 52.2 ± 8.4 | 51.4 ± 8.1 | 51.2 ± 7.7 | 50.6 ± 8.3 | 0.1 ± 0.3 | 0.1 ± 0.3 |
| T5 | 44.2 ± 14.9 | 43.4 ± 14.8 | 43.4 ± 14.6 | 43.4 ± 14.6 | 0.1 ± 0.3 | 0.1 ± 0.3 |
| T6 | 54.3 ± 7.3 | 54.4 ± 7.2 | 54.1 ± 7.4 | 54.3 ± 7.6 | 0.1 ± 0.3 | 0.1 ± 0.3 |
| 13-no | 57.1 ± 17.1 | 57.5 ± 17.2 | 57.5 ± 17.0 | 57.2 ± 17.2 | 0.1 ± 0.3 | 0.1 ± 0.3 |
| treatment | | | | | | |
| Total | 50.8 ± 12.0 | 50.5 ± 12.1 | 50.3 ± 12.0 | 50.3 ± 12.0 | 0.2 ± 0.4 | 0.2 ± 0.4 |
| Average | | | | | | |

| | Discoloration* | | Necrosis** | | | |
|---|---|---|---|---|---|---|
| Treatment | January | February | November | December | January | February |
| T1 | 0.3 ± 0.5 | 0.3 ± 0.5 | 0.5 ± 0.5 | 0.5 ± 0.5 | 0.5 ± 0.5 | 0.5 ± 0.5 |
| T2 | 0.2 ± 0.6 | 0.2 ± 0.6 | 0.7 ± 0.7 | 0.7 ± 0.7 | 0.7 ± 0.7 | 0.7 ± 0.7 |
| T3 | 0.3 ± 0.5 | 0.3 ± 0.5 | 0.4 ± 0.5 | 0.4 ± 0.5 | 0.4 ± 0.5 | 0.4 ± 0.5 |
| T4 | 0.1 ± 0.3 | 0.1 ± 0.3 | 0.6 ± 0.7 | 0.6 ± 0.7 | 0.6 ± 0.7 | 0.6 ± 0.7 |
| T5 | 0.1 ± 0.3 | 0.1 ± 0.3 | 0.1 ± 0.3 | 0.1 ± 0.3 | 0.1 ± 0.3 | 0.1 ± 0.3 |
| T6 | 0.1 ± 0.3 | 0.1 ± 0.3 | 0.4 ± 0.5 | 0.4 ± 0.5 | 0.4 ± 0.5 | 0.4 ± 0.5 |
| 13-no | 0.1 ± 0.3 | 0.2 ± 0.4 | 0.3 ± 0.5 | 0.3 ± 0.5 | 0.3 ± 0.5 | 0.3 ± 0.5 |
| treatment | | | | | | |
| Total | 0.2 ± 0.4 | 0.2 ± 0.4 | 0.4 ± 0.6 | 0.4 ± 0.6 | 0.4 ± 0.6 | 0.4 ± 0.6 |
| Average | | | | | | |

*Discoloration of leaves, scale: 0 = no symptoms; 1 = light leaf chlorosis; 2 = leaf chlorosis up to 25%; 3 = 26-50% of chlorotic leaves; 4 = 51-90% of chlorotic; 5 = plant death.
**Necrosis, scale: 0 = no symptoms; 1 = light leaf necrosis; 2 = leaf necrosis up to 25%; 3 = 26-50% of necrotic leaves; 4 = 51-90% of necrotic leaves; 5 = plant death

TABLE 8

| | CCI | | | | Discoloration* | |
|---|---|---|---|---|---|---|
| Treatment | November | December | January | February | November | December |
| T7 | 45.9 ± 10.8 | 45.7 ± 11.1 | 45.7 ± 11.1 | 45.7 ± 11.0 | 0.2 ± 0.4 | 0.2 ± 0.4 |
| T8 | 52.0 ± 10.0 | 52.4 ± 10.4 | 52.210.1 ± | 52.3 ± 10.1 | 0.1 ± 0.3 | 0.1 ± 0.3 |
| T9 | 52.2 ± 10.6 | 50.8 ± 10.6 | 50.9 ± 10.8 | 50.9 ± 10.8 | 0.0 ± 0.0 | 0.0 ± 0.0 |
| T10 | 53.7 ± 12.3 | 53.9 ± 12.6 | 53.8 ± 12.4 | 53.9 ± 12.3 | 0.5 ± 0.5 | 0.5 ± 0.5 |
| T11 | 47.9 ± 13.1 | 48.4 ± 12.7 | 48.4 ± 12.7 | 48.1 ± 13.1 | 0.1 ± 0.3 | 0.1 ± 0.3 |
| T12 | 50.7 ± 12.2 | 50.4 ± 12.1 | 50.1 ± 12.9 | 50.3 ± 12.6 | 0.1 ± 0.3 | 0.1 ± 0.3 |
| 13-no | 57.1 ± 17.1 | 57.5 ± 17.2 | 57.5 ± 17.0 | 57.2 ± 17.2 | 0.1 ± 0.3 | 0.1 ± 0.3 |
| treatment | | | | | | |
| Total | 50.8 ± 12.0 | 50.5 ± 12.1 | 50.3 ± 12.0 | 50.3 ± 12.0 | 0.2 ± 0.4 | 0.2 ± 0.4 |
| Average | | | | | | |

| | Discoloration* | | Necrosis** | | | |
|---|---|---|---|---|---|---|
| Treatment | January | February | November | December | January | February |
| T7 | 0.2 ± 0.4 | 0.2 ± 0.4 | 0.4 ± 0.7 | 0.4 ± 0.7 | 0.4 ± 0.7 | 0.4 ± 0.7 |
| T8 | 0.2 ± 0.4 | 0.2 ± 0.4 | 0.4 ± 0.5 | 0.4 ± 0.5 | 0.4 ± 0.5 | 0.4 ± 0.5 |
| T9 | 0.1 ± 0.3 | 0.1 ± 0.3 | 0.2 ± 0.4 | 0.2 ± 0.4 | 0.2 ± 0.4 | 0.2 ± 0.4 |
| T10 | 0.5 ± 0.5 | 0.5 ± 0.5 | 0.7 ± 0.7 | 0.7 ± 0.7 | 0.7 ± 0.7 | 0.7 ± 0.7 |
| T11 | 0.1 ± 0.3 | 0.1 ± 0.3 | 0.5 ± 0.5 | 0.5 ± 0.5 | 0.5 ± 0.5 | 0.5 ± 0.5 |
| T12 | 0.2 ± 0.4 | 0.2 ± 0.4 | 0.5 ± 0.5 | 0.5 ± 0.5 | 0.5 ± 0.5 | 0.6 ± 0.7 |
| 13-no | 0.1 ± 0.3 | 0.2 ± 0.4 | 0.3 ± 0.5 | 0.3 ± 0.5 | 0.3 ± 0.5 | 0.3 ± 0.5 |
| treatment | | | | | | |
| Total | 0.2 ± 0.4 | 0.2 ± 0.4 | 0.4 ± 0.6 | 0.4 ± 0.6 | 0.4 ± 0.6 | 0.4 ± 0.6 |
| Average | | | | | | |

*Discoloration of leaves, scale: 0 = no symptoms; 1 = light leaf chlorosis; 2 = leaf chlorosis up to 25%; 3 = 26-50% of chlorotic leaves; 4 = 51-90% of chlorotic; 5 = plant death.
**Necrosis, scale: 0 = no symptoms; 1 = light leaf necrosis; 2 = leaf necrosis up to 25%; 3 = 26-50% of necrotic leaves; 4 = 51-90% of necrotic leaves; 5 = plant death

TABLE 9

| | CCI | | | | Discoloration* | |
|---|---|---|---|---|---|---|
| Treatment | November | December | January | February | November | December |
| T1 | 27.3 ± 4.8 | 27.2 ± 4.7 | 27.4 ± 4.5 | 28.0 ± 5.6 | 0.0 ± 0.0 | 0.1 ± 0.3 |
| T2 | 33.4 ± 10.6 | 34.3 ± 10.1 | 33.5 ± 9.4 | 42.9 ± 11.8 | 0.0 ± 0.0 | 0.0 ± 0.0 |
| T3 | 34.5 ± 8.8 | 34.8 ± 8.9 | 34.3 ± 8.9 | 39.9 ± 8.9 | 0.0 ± 0.0 | 0.1 ± 0.3 |
| T4 | 29.8 ± 10.0 | 29.8 ± 10.1 | 29.8 ± 10.1 | 42.4 ± 10.2 | 0.0 ± 0.0 | 0.1 ± 0.3 |
| T5 | 38.2 ± 9.5 | 38.0 ± 9.6 | 37.9 ± 9.4 | 34.7 ± 9.4 | 0.0 ± 0.0 | 0.0 ± 0.0 |
| T6 | 37.3 ± 6.0 | 36.7 ± 6.6 | 35.8 ± 5.8 | 34.5 ± 5.7 | 0.0 ± 0.0 | 0.1 ± 0.3 |
| 13-no | 32.8 ± 6.9 | 32.3 ± 6.7 | 32.6 ± 6.9 | 32.1 ± 7.2 | 0.0 ± 0.0 | 0.1 ± 0.3 |
| treatment | | | | | | |
| Total | 36.7 ± 9.7 | 36.7 ± 9.7 | 36.6 ± 9.6 | 36.7 ± 9.8 | 0.0 ± 0.0 | 0.1 ± 0.2 |
| average | | | | | | |

| | Discoloration* | | Necrosis** | | | |
|---|---|---|---|---|---|---|
| Treatment | January | February | November | December | January | February |
| T1 | 0.1 ± 0.3 | 0.1 ± 0.3 | 0.2 ± 0.4 | 0.2 ± 0.4 | 0.2 ± 0.4 | 0.2 ± 0.4 |
| T2 | 0.0 ± 0.0 | 0.1 ± 0.0 | 0.1 ± 0.3 | 0.1 ± 0.3 | 0.1 ± 0.3 | 0.1 ± 0.3 |
| T3 | 0.1 ± 0.3 | 0.0 ± 0.3 | 0.0 ± 0.0 | 0.0 ± 0.0 | 0.0 ± 0.0 | 0.0 ± 0.0 |
| T4 | 0.1 ± 0.3 | 0.0 ± 0.3 | 0.1 ± 0.3 | 0.1 ± 0.3 | 0.1 ± 0.3 | 0.0 ± 0.3 |
| T5 | 0.0 ± 0.0 | 0.0 ± 0.0 | 0.0 ± 0.0 | 0.0 ± 0.0 | 0.0 ± 0.0 | 0.1 ± 0.0 |
| T6 | 0.1 ± 0.3 | 0.1 ± 0.3 | 0.1 ± 0.3 | 0.1 ± 0.3 | 0.1 ± 0.3 | 0.0 ± 0.3 |
| 13-no | 0.1 ± 0.3 | 0.1 ± 0.3 | 0.1 ± 0.3 | 0.1 ± 0.3 | 0.1 ± 0.3 | 0.1 ± 0.3 |
| treatment | | | | | | |
| Total | 0.1 ± 0.2 | 0.1 ± 0.2 | 0.1 ± 0.2 | 0.1 ± 0.2 | 0.1 ± 0.2 | 0.1 ± 0.2 |
| average | | | | | | |

*Discoloration of leaves, scale: 0 = no symptoms; 1 = light leaf chlorosis; 2 = leaf chlorosis up to 25%; 3 = 26-50% of chlorotic leaves; 4 = 51-90% of chlorotic; 5 = plant death.
**Necrosis, scale: 0 = no symptoms; 1 = light leaf necrosis; 2 = leaf necrosis up to 25%; 3 = 26-50% of necrotic leaves; 4 = 51-90% of necrotic leaves; 5 = plant death

TABLE 10

| | CCI | | | | Discoloration* | |
|---|---|---|---|---|---|---|
| Treatment | November | December | January | February | November | December |
| T7 | 39.3 ± 7.7 | 39.4 ± 7.1 | 39.5 ± 7.1 | 30.3 ± 7.7 | 0.0 ± 0.0 | 0.1 ± 0.3 |
| T8 | 41.3 ± 9.1 | 41.3 ± 9.2 | 41.3 ± 9.2 | 37.9 ± 9.0 | 0.0 ± 0.0 | 0.0 ± 0.0 |
| T9 | 38.2 ± 10.1 | 38.2 ± 10.4 | 38.7 ± 10.8 | 35.9 ± 11.3 | 0.0 ± 0.0 | 0.0 ± 0.0 |
| T10 | 43.4 ± 10.6 | 43.0 ± 10.6 | 42.9 ± 10.6 | 38.9 ± 10.6 | 0.0 ± 0.0 | 0.1 ± 0.3 |
| T11 | 39.7 ± 10.1 | 39.6 ± 10.3 | 40.1 ± 10.1 | 41.7 ± 10.1 | 0.0 ± 0.0 | 0.0 ± 0.0 |
| T12 | 42.2 ± 8.9 | 42.3 ± 9.0 | 42.4 ± 9.2 | 38.0 ± 9.5 | 0.0 ± 0.0 | 0.0 ± 0.0 |
| 13-no | 32.8 ± 6.9 | 32.3 ± 6.7 | 32.6 ± 6.9 | 32.1 ± 7.2 | 0.0 ± 0.0 | 0.1 ± 0.3 |
| treatment | | | | | | |
| Total | 36.7 ± 9.7 | 36.7 ± 9.7 | 36.6 ± 9.6 | 36.7 ± 9.8 | 0.0 ± 0.0 | 0.1 ± 0.2 |
| average | | | | | | |

| | Discoloration* | | Necrosis** | | | |
|---|---|---|---|---|---|---|
| Treatment | January | February | November | December | January | February |
| T7 | 0.1 ± 0.3 | 0.1 ± 0.3 | 0.0 ± 0.0 | 0.0 ± 0.0 | 0.0 ± 0.0 | 0.1 ± 0.0 |
| T8 | 0.0 ± 0.0 | 0.0 ± 0.0 | 0.0 ± 0.0 | 0.0 ± 0.0 | 0.0 ± 0.0 | 0.0 ± 0.0 |
| T9 | 0.0 ± 0.0 | 0.1 ± 0.0 | 0.0 ± 0.0 | 0.0 ± 0.0 | 0.0 ± 0.0 | 0.1 ± 0.0 |
| T10 | 0.1 ± 0.3 | 0.1 ± 0.3 | 0.10.3 ± | 0.1 ± 0.3 | 0.1 ± 0.3 | 0.0 ± 0.3 |
| T11 | 0.0 ± 0.0 | 0.0 ± 0.0 | 0.0 ± 0.0 | 0.0 ± 0.0 | 0.0 ± 0.0 | 0.0 ± 0.0 |
| T12 | 0.0 ± 0.0 | 0.0 ± 0.0 | 0.0 ± 0.0 | 0.0 ± 0.0 | 0.0 ± 0.0 | 0.0 ± 0.0 |
| 13-no | 0.1 ± 0.3 | 0.1 ± 0.3 | 0.1 ± 0.3 | 0.1 ± 0.3 | 0.1 ± 0.3 | 0.1 ± 0.3 |
| treatment | | | | | | |
| Total | 0.1 ± 0.2 | 0.1 ± 0.2 | 0.1 ± 0.2 | 0.1 ± 0.2 | 0.1 ± 0.2 | 0.1 ± 0.2 |
| average | | | | | | |

*Discoloration of leaves, scale: 0 = no symptoms; 1 = light leaf chlorosis; 2 = leaf chlorosis up to 25%; 3 = 26-50% of chlorotic leaves; 4 = 51-90% of chlorotic; 5 = plant death.
**Necrosis, scale: 0 = no symptoms; 1 = light leaf necrosis; 2 = leaf necrosis up to 25%; 3 = 26-50% of necrotic leaves; 4 = 51-90% of necrotic leaves; 5 = plant death

### Nursery Experiments

The same twelve experimental treatment conditions and no-treatment control described above (T1-T12, and 13) were tested on nursery palm trees in the field to evaluate the efficacy of the treatment at preventing red palm weevil infestation. A total of 572 potted palm trees (286 P. dactylifera and 286 P. canariensis) were evaluated in the nursery experiments.

The two species were positioned in two separate blocks, one for each species. The distance of each palm from its nearest neighbor was about one meter. Date palms were from 9 to 13 years old, with an average diameter at the base of 20.1 cm; canary palms were from 7 to 8 years old, with an average diameter at the base of 17.8 cm. All treated palms were healthy at the beginning of the project, as evaluated by visual inspection, stethoscope and thermal camera measurements.

Treatments were performed inside the two blocks of palms on 14-16 October. The coatings were applied by painting and spraying (Black & Decker—SmartSelect HVLP Sprayer model BDPH400). To avoid effects of wind drift, the treatments were performed on days without wind.

Thirty-three infested trees (i.e. palms infested from the beginning of the test, before any treatment) were distributed uniformly inside the experimental area (28 date palm trees and 5 canary palm trees) to ensure the presence of the red palm weevil within the area. Sixteen of these infested trees were treated to evaluate a possible curative effect.

Forty-four palm trees were not treated (22 date palms and 22 canary palms) and were distributed uniformly inside the experimental area.

During the months of August and September, the trees were irrigated every two days; in October every four days; and from November to March every seven days. The trees were fertilized in October with COMPO NPK Original Gold®, in an amount of 5-10 g per pot. Average monthly air temperatures during the test were as shown in Table 11.

TABLE 11

| Month | Temperature ° C. |
|---|---|
| August | 26.0 |
| September | 22.7 |
| October | 20.1 |
| November | 14.1 |
| December | 10.3 |
| January | 10.3 |
| February | 11.5 |
| March | 10.9 |

Thickness measurements, CCI measurements, and visual examinations (including with the aid of a thermal camera and stethoscope) of the nursery trees were performed in November, December, February, March and April. The thickness values of the coating films in the nursery experiments were comparable to those in the greenhouse experiments (approximately 0.250 mm for vinyl acetate treatments and approximately 0.09 mm for raw linseed oil treatments).

Table 12 shows average thickness values of coating films for each vinyl acetate treatment condition on P. dactylifera in the nursery experiments in March. No significant differences were observed based on an analysis of variance test (ANOVA p≦0.05).

TABLE 12

| Treatment | Average Thickness (μm) |
|---|---|
| T1 | 220.1 ± 52.9a |
| T2 | 232.1 ± 56.8a |
| T3 | 232.8 ± 47.4a |
| T4 | 212.0 ± 61.8a |
| T5 | 261.5 ± 51.9a |
| T6 | 236.8 ± 41.7a |

Table 13 shows average thickness values of coating films for each raw linseed oil treatment condition on P. dactylifera in the nursery experiments in March. No significant differences were observed based on an analysis of variance test (ANOVA p≦0.05).

TABLE 13

| Treatment | Average Thickness (μm) |
|---|---|
| T7 | 86.4 ± 17.6a |
| T8 | 86.4 ± 16.8a |
| T9 | 96.8 ± 17.8a |
| T10 | 85.8 ± 18.2a |
| T11 | 81.9 ± 11.3a |
| T12 | 73.4 ± 13.4a |

Table 14 shows average thickness values of coating films for each vinyl acetate treatment condition on P. canariensis in the nursery experiments in March. No significant differences were observed based on an analysis of variance test (ANOVA p≦0.05).

TABLE 14

| Treatment | Average Thickness (μm) |
|---|---|
| T1 | 209.0 ± 20.3a |
| T2 | 244.6 ± 36.4a |
| T3 | 224.6 ± 48.8a |
| T4 | 229.5 ± 61.8a |
| T5 | 230.7 ± 50.0a |
| T6 | 254.0 ± 34.1a |

Table 15 shows average thickness values of coating films for each raw linseed oil treatment condition on P. canariensis in the nursery experiments in March. No significant differences were observed based on an analysis of variance test (ANOVA p≦0.05).

TABLE 15

| Treatment | Average Thickness (μm) |
|---|---|
| T7 | 89.0 ± 20.0a |
| T8 | 88.5 ± 16.9a |
| T9 | 86.8 ± 15.6a |
| T10 | 79.5 ± 22.0a |
| T11 | 72.7 ± 17.3a |
| T12 | 72.4 ± 11.6a |

Table 16 shows average CCI values for each vinyl acetate treatment condition on P. dactylifera in the nursery experiments in March. No significant differences were observed based on an analysis of variance test (ANOVA p≦0.05).

TABLE 16

| Treatment | Average CCI |
|---|---|
| T1 | 10.6 ± 4.3a |
| T2 | 10.9 ± 4.2a |
| T3 | 11.3 ± 5.7a |
| T4 | 15.2 ± 3.5a |
| T5 | 19.3 ± 8.3a |
| T6 | 11.7 ± 1.5a |

Table 17 shows average CCI values for each raw linseed oil treatment condition on P. dactylifera in the nursery experiments in March. No significant differences were observed based on an analysis of variance test (ANOVA p≦0.05).

TABLE 17

| Treatment | Average CCI |
|---|---|
| 8 | 26.3 ± 13.5a |
| 9 | 8.9 ± 4.1a |
| 10 | 25.3 ± 10.9a |
| 11 | 23.2 ± 8.7a |
| 12 | 15.6 ± 6.9a |

Table 18 shows average CCI values for each vinyl acetate treatment condition on P. canariensis in the nursery experiments in March. No significant differences were observed based on an analysis of variance test (ANOVA p≦0.05).

TABLE 18

| Treatment | Average CCI |
|---|---|
| T1 | 16.3 ± 6.0a |
| T2 | 15.2 ± 4.5a |
| T3 | 14.1 ± 3.7a |
| T4 | 11.7 ± 1.9a |
| T5 | 15.3 ± 7.9a |
| T6 | 16.3 ± 4.1a |

Table 19 shows average CCI values for each raw linseed oil treatment condition on P. canariensis in the nursery experiments in March. No significant differences were observed based on an analysis of variance test (ANOVA p≦0.05).

TABLE 19

| Treatment | Average CCI |
|---|---|
| T7 | 13.4 ± 2.4a |
| T8 | 12.4 ± 0.9a |
| T9 | 9.0 ± 2.9a |
| T10 | 15.0 ± 3.2a |
| T11 | 12.4 ± 2.1a |
| T12 | 10.8 ± 2.7a |

210 days after treatment, 18 new infestations of red palm weevil were observed (13 date palms and 5 canary palms) as follows:

7 negative control palms that had not been treated: 4 date palms and 3 canary palms; and

11 palms that had been treated with insecticide-free liquid suspensions:
3 with vinyl acetate based products (2 with camphor and 1 without camphor);
8 with raw linseed oil based products (3 with camphor and 5 without camphor).
   Notably, none of the palms treated with insecticides showed signs of infestation 210 days after the treatment.

### Date Palm Results

After 210 days, 13 date palms were infested by red palm weevil: 4 negative controls, 2 treated with vinyl acetate products (but without insecticide) and 7 treated with raw linseed oil (but without insecticide), as summarized in Table 20.

TABLE 20

| | number | time |
|---|---|---|
| Treated date palms (healthy) | 264 | |
| Untreated palms (control) | 22 | |
| Number of treatments | 12 | |
| Number of date palms for each treatment | 22 | |
| Number of palms infested | 5 | after 110 days |
| | 7 | after 152 days |
| | 10 | after 180 days |
| | 13 | after 210 days |

Nine of the 264 treated date palms and four of the 22 untreated date palms were infested after 210 days. The infested palms belonged to the treatment conditions shown in Table 21.

TABLE 21

| | after | after | after | after | |
|---|---|---|---|---|---|
| Treat- | 110 | 152 | 180 | 210 | |
| ment | days | days | days | days | notes |
| T1 | 1 | 1 | 2 | 2 | Treatment with Vinyl acetate, |
| | | | | | Water and Camphor White oil |
| T11 | 2 | 3 | 4 | 5 | Treatment with Raw Linseed oil |
| | | | | | and Limonene |
| T12 | — | 1 | 2 | 2 | Treatment with Raw Linseed oil, |
| | | | | | Limonene and Camphor White oil |
| Control | 2 | 2 | 2 | 4 | No treatment |
| Total | 5 | 7 | 10 | 13 | |

Comparing the results obtained on date palms between the treatments T1-T12 and controls, after 210 days there was a significant difference (ANOVA p≦0.05) only between the palm trees treated with the T11 condition and all the others, as shown in Table 22 (where a healthy palm was scored as 0, and an infested palm was scored as 100).

TABLE 22

| | Valid | Mean ± Std. Error |
|---|---|---|
| Treatment | cases | of Mean |
| T1 | 22 | 9.09 ± 6.27a |
| T2 | 22 | 0 ± 0a |
| T3 | 22 | 0 ± 0a |
| T4 | 22 | 0 ± 0a |
| T5 | 22 | 0 ± 0a |
| T6 | 22 | 0 ± 0a |
| T7 | 22 | 0 ± 0a |
| T8 | 22 | 0 ± 0a |
| T9 | 22 | 0 ± 0a |
| T10 | 22 | 0 ± 0a |
| T11 | 22 | 22.72 ± 9.14b |
| T12 | 22 | 9.09 ± 6.27a |
| CONTROL | 22 | 18.18 ± 8.41b |

Comparing the results obtained among the date palms treated with vinyl acetate (T1-T6), linseed oil (T7-T12) and controls, after 180 days there was a significant difference (ANOVA p≦0.05), as shown in Table 23.

TABLE 23

| Treatment | Mean ± Std. Error of Mean |
|---|---|
| T1/T6 (vinyl acetate | 1.51 ± 1.07a |
| based products) | |
| T7/T12 (raw linseed oil | 4.54 ± 1.07b |
| based products) | |
| Control | 9.09 ± 6.27b |

Comparing the results among the date palms treated with linseed oil (with or without insecticides), vinyl acetate (with or without insecticides) and controls, after 180 days there were significant differences (ANOVA p≧0.05), as shown in Table 24.

TABLE 24

| Treatment | Mean ± Std. Error of Mean |
|---|---|
| T1, T4 (vinyl acetate | 4.54 ± 3.18ab |
| based products without | |
| insecticide) | |
| T2, T3, T5, T6 (vinyl | 0.0 ± 0.00a |
| acetate based products | |
| with insecticide) | |
| T7, T8, T9, T10 (raw | 0.0 ± 0.0a |
| linseed oil based | |
| products with | |
| insecticide) | |
| T11-T12 (raw linseed oil | 13.64 ± 5.23b |
| based products without | |
| insecticide) | |
| Control | 9.09 ± 6.27b |

Comparing the results among the date palms treated with insecticides (vinyl acetate and linseed oil), those treated without insecticides (vinyl acetate and linseed oil) and controls, after 180 days there were significant differences (ANOVA p≦0.05), as shown in Table 25.

TABLE 25

| Treatment | Mean ± Std. Error of Mean |
|---|---|
| products without insecticide | 9.09 ± 3.08a |
| (T1, T4, T11, T12) | |
| products with insecticide | 0.0 ± 0.00b |
| (T2, T3, T5, T6, T7, T8, T9, | |
| T10) | |
| Control | 9.09 ± 6.27a |

Comparing the results among the date palms treated with products (with or without camphor oil) and controls, after 180 days there were significant differences (ANOVA p≦0.05), as shown in Table 26.

TABLE 26

| Treatment | Mean ± Std. Error of Mean |
|---|---|
| products without white | 9.09 ± 4.38a |
| camphor oil (T4, T11) | |
| products with white | 1.82 ± 0.90b |
| camphor oil (T1, T2, T3, | |
| T5, T6, T7, T8, T9, T10, | |
| T12) | |
| Control | 9.09 ± 6.27ab |

### Canary Palm Results

After 210 days, 5 canary palms were infested by red palm weevil: 3 negative controls, 1 treated with vinyl acetate products (but without insecticide) and 1 treated with raw linseed oil (but without insecticide), as summarized in Table 27.

TABLE 27

| | number | time |
|---|---|---|
| Treated canary palms (healthy) | 264 | |
| Untreated palms (control) | 22 | |
| Number of treatments | 12 | |
| Number of Canary palms for each treatment | 22 | |
| Number of palms infested | 3 | after 110 days |
| | 3 | after 152 days |
| | 4 | after 180 days |
| | 5 | after 210 days |

Two of the 264 treated canary palms and three of the 22 untreated were infested after 210 days. The infested palms belonged to the treatment conditions shown in Table 28.

TABLE 28

| | after | after | after | after | |
|---|---|---|---|---|---|
| Treat- | 110 | 152 | 180 | 210 | |
| ment | days | days | days | days | notes |
| T4 | 1 | 1 | 1 | 1 | Treatment with Vinyl acetate and |
| | | | | | Water |
| T12 | 1 | 1 | 1 | 1 | Treatment with Raw Linseed oil, |
| | | | | | Limonene and Camphor White oil |
| Control | 1 | 1 | 2 | 3 | No treatment |
| Total | 3 | 3 | 4 | 5 | |

Comparing the results obtained on canary palms between the treatments T1-T12 and controls, after 210 days there was a significant difference (ANOVA p≦0.05) between the control palm trees and the other treatments, except for T4 and T12, as shown in Table 29 (where a healthy palm was scored as 0, and an infested palm was scored as 100).

TABLE 29

| | Valid | Mean ± Std. Error |
|---|---|---|
| Treatment | cases | of Mean |
| T1 | 22 | 0 ± 0a |
| T2 | 22 | 0 ± 0a |
| T3 | 22 | 0 ± 0a |
| T4 | 22 | 4.54 ± 4.54ab |
| T5 | 22 | 0 ± 0a |
| T6 | 22 | 0 ± 0a |
| T7 | 22 | 0 ± 0a |
| T8 | 22 | 0 ± 0a |
| T9 | 22 | 0 ± 0a |
| T10 | 22 | 0 ± 0a |
| T11 | 22 | 0 ± 0a |
| T12 | 22 | 4.54 ± 4.54ab |
| CONTROL | 22 | 13.63 ± 7.49b |

Comparing the results obtained among the canary palms treated with vinyl acetate (T1-T6), linseed oil (T7-T12) and controls, after 180 days there was also a significant difference (ANOVA p≦0.05), as shown in Table 30.

TABLE 30

| Treatment | Mean ± Std. Error of Mean |
|---|---|
| T1, T4 (vinyl acetate | 2.27 ± 2.27a |
| based products without | |
| insecticide) | |
| T2, T3, T5, T6 (vinyl | 0.0 ± 0.00a |
| acetate based products | |
| with insecticide) | |
| T7, T8, T9, T10 (raw | 0.0 ± 0.0a |
| linseed oil based | |
| products with | |
| insecticide) | |
| T11, T12 (raw linseed | 2.27 ± 2.27a |
| oil based products | |
| without insecticide) | |
| Control | 9.09 ± 6.27b |

Comparing the results among the canary palms treated with linseed oil (with or without insecticides), vinyl acetate (with or without insecticides) and controls, after 180 days there were also significant differences (ANOVA p≦0.05), as shown in Table 31.

TABLE 31

| Treatment | Mean ± Std. Error of Mean |
|---|---|
| T1/T6 (vinyl acetate | 0.75 ± 0.75a |
| based products) | |
| T7/T12 (raw linseed oil | 0.75 ± 0.75a |
| based products) | |
| Control | 9.09 ± 6.27b |

Comparing the results among the canary palms treated with insecticides (vinyl acetate and linseed oil), those treated without insecticides (vinyl acetate and linseed oil) and controls, after 180 days there were significant differences (ANOVA p≦0.05), as shown in Table 32.

TABLE 32

| Treatment | Mean ± Std. Error of Mean |
|---|---|
| products without insecticide | 2.27 ± 1.59a |
| (T1, T4, T11, T12) | |
| products with insecticide | 0.0 ± 0.00a |
| (T2, T3, T5, T6, T7, T8, T9, | |
| T10) | |
| Control | 9.09 ± 6.27b |

Comparing the results among the canary palms treated with products (with or without camphor oil) and controls, after 180 days there were significant differences (ANOVA p≦0.05) between the controls and others, as shown in Table 33.

TABLE 33

| Treatment | Mean ± Std. Error of Mean |
|---|---|
| products without white | 2.27 ± 2.27a |
| camphor oil (T4, T11) | |
| products with white | 0.45 ± 0.45a |
| camphor oil (T1, T2, T3, | |
| T5, T6, T7, T8, T9, T10, | |
| T12) | |
| Control | 9.09 ± 6.27b |

Canary and Date Palm Combined Results

After 210 days, 18 palms were infested: 13 date palms and 5 canary palms. The 18 infested palms belonged to the following treatment groups: 7 controls, 3 treated with vinyl acetate product (but without insecticide) and 8 treated with raw linseed oil (but without insecticide), as summarized in Table 34.

TABLE 34

| | number | notes |
|---|---|---|
| Treated palms (healthy) | 528 | |
| Untreated palms (control) | 44 | |
| Number of treatments | 12 | |
| Number of palms for each treatment | 44 | |
| Number of palms infested | 8 | after 110 days |
| | 10 | after 152 days |
| | 14 | after 180 days |
| | 18 | after 210 days |

The infested palms belonged to the treatment conditions shown in Table 35.

TABLE 35

| | after | after | after | after | |
|---|---|---|---|---|---|
| Treat- | 110 | 152 | 180 | 210 | |
| ment | days | days | days | days | notes |
| T1 | 1 | 1 | 2 | 2 | Treatment with Vinyl acetate, |
| | | | | | Water and Camphor White oil |
| T4 | 1 | 1 | 1 | 1 | Treatment with Vinyl acetate |
| | | | | | and Water |
| T11 | 2 | 3 | 4 | 5 | Treatment with Raw Linseed oil |
| | | | | | and Limonene |
| T12 | 1 | 2 | 3 | 3 | Treatment with Raw Linseed oil, |
| | | | | | Limonene and Camphor White oil |
| Control | 3 | 3 | 4 | 7 | No treatment |
| Total | 8 | 10 | 14 | 18 | |

Comparing the results obtained after 210 days there was a significant difference (ANOVA p≦0.05) among the controls and the other treatments, except for T11, as shown in Table 36 (where a healthy palm was scored as 0, and an infested palm was scored as 100).

TABLE 36

| | Valid | Mean ± Std. Error |
|---|---|---|
| Treatment | cases | of Mean |
| T1 | 44 | 4.54 ± 3.17abc |
| T2 | 44 | 0 ± 0a |
| T3 | 44 | 0 ± 0a |
| T4 | 44 | 2.27 ± 2.27ab |
| T5 | 44 | 0 ± 0a |
| T6 | 44 | 0 ± 0a |
| T7 | 44 | 0 ± 0a |
| T8 | 44 | 0 ± 0a |
| T9 | 44 | 0 ± 0a |
| T10 | 44 | 0 ± 0a |
| T11 | 44 | 11.36 ± 4.84bc |
| T12 | 44 | 6.18 ± 3.84ab |
| CONTROL | 44 | 15.91 ± 5.58c |

Comparing the results obtained among the palms treated with vinyl acetate (T1-T6), linseed oil (T7-T12) and controls, after 180 days there was also a significant difference (ANOVA p≦0.05), as shown in Table 37.

TABLE 37

| Treatment | Mean ± Std. Error of Mean |
|---|---|
| T1/T6 (vinyl acetate | 1.14 ± 0.65a |
| based products) | |
| T7/T12 (raw linseed oil | 2.65 ± 0.99a |
| based products) | |
| Control | 9.09 ± 4.38b |

Comparing the results among the palms treated with linseed oil (with or without insecticides), vinyl acetate (with or without insecticides) and controls, after 180 days there were also significant differences (ANOVA p≦0.05), as shown in Table 38.

TABLE 38

| Treatment | Mean ± Std. Error of Mean |
|---|---|
| T1, T4 (vinyl acetate based products without | 3.41 ± 1.94a |
| insecticide) | |
| T2, T3, T5, T6 (vinyl acetate based products | 0.0 ± 0.00a |
| with insecticide) | |
| T7, T8, T9, T10 (raw linseed oil based | 0.0 ± 0.0a |
| products with insecticide) | |
| T11, T12 (raw linseed oil based products | 7.95 ± 2.90b |
| without insecticide) | |
| Control | 9.09 ± 4.38b |

Comparing the results among the palm trees treated with insecticides (vinyl acetate and linseed oil), those treated without insecticides (vinyl acetate and linseed oil) and controls, after 180 days there were significant differences (ANOVA p≦0.05), as shown in Table 39.

TABLE 39

| Treatment | Mean ± Std. Error of Mean |
|---|---|
| products without insecticide | 5.68 ± 1.75a |
| (T1, T4, T11, T12) | |
| products with insecticide | 0.0 ± 0.00b |
| (T2, T3, T5, T6, T7, T8, T9, | |
| T10) | |
| Control | 9.09 ± 4.38a |

Comparing the results among the palms treated (with or without camphor oil) and controls, after 180 days there were significant differences (ANOVA p≦0.05), as shown in Table 40

TABLE 40

| Treatment | Mean ± Std. Error of Mean |
|---|---|
| products without white | 5.68 ± 2.48a |
| camphor oil (4, 11) | |
| products with white | 1.14 ± 0.51b |
| camphor oil (1, 2, 3, 5, | |
| 6, 7, 8, 9, 10, 12) | |
| Control | 9.09 ± 4.38a |

After 210 days, 11.8% of date palms and 4.5% of canary palms not treated (condition 13) or treated with insecticide-free solutions (conditions T1, T4, T11 and T12) were gradually infested. However, no palms treated with insecticide solutions were infested (conditions T2, T3 and T5-T10). Accordingly, these results demonstrate the efficacy of the inventive method at preventing infestation of palm trees by the red palm weevil.

### Nursery Activity (Sicily)—400 Days

As described herein 572 palm trees were treated in the field to evaluate the efficacy of the treatment compositions and treatments methods using 286 P. dactylifera and 286 P. canariensis palm trees. The two species were positioned in two separate blocks. The distance of each palm from the others was 1 meter.

Date palms were from 9 to 13 years old, with an average diameter at base of 20.1 cm; Canary palm were from 7 to 8 years old with an average diameter at base of 17.8 cm. All palms were started from seed. All treated palms were healthy. Healthy status was checked by ANT using visual inspection, stethoscope and thermal camera measurements.

Treatments were carried out randomly inside the two blocks of palms during 14-16 Oct. 2013, the coatings were applied by brush and by spray (Black & Decker—SmartSelect HVLP Sprayer mod. BDPH400). To avoid wind drift effect, the treatments were made on days without wind.

Thirty three infested trees (palms infested from the beginning of the test—before treatments) were positioned inside the experimental area (28 date palm trees and 5 Canary palm tree) to ensure the presence of the insect (red palm weevil) within the area. Infested trees were distributed uniformly in the experimental area.

Forty four palm trees were not treated (22 P. dactylifera and 22 P. canariensis). In the months of August and September the trees were irrigatedevery 2 days, in October every 4 days; from November to March every 7 days; and from April to June every 3 days. The trees were fertilized in October and in May—COMPO NPK Original Gold®, 5-10 g per pot.

The products applied in field were the same as the products and compositions applied in the greenhouse tests described hereinabove (see table 41 below).

TABLE 41
The following protocol was used for the trial.

| Treatment | Coating | Solvent | Insecticide | Repellent |
|---|---|---|---|---|
| T1 | Vinyl acetate 59 (100 g) | 38.7 g H2O | Not used | 5 g Camphor White oil |
| T2 | Vinyl acetate 59 (100 g) | 109.3 g H2O | 40 g Teflustar | 5 g Camphor White oil |
| | | | (0.08 g teflutrin) | |
| T3 | Vinyl acetate 59 (100 g) | 109.3 g H2O | 20 g Teflustar | 5 g Camphor White oil |
| | | | (0.04 g teflutrin) | |
| T4 | Vinyl acetate 59 (100 g) | 38.7 g H2O | Not used | Not used |
| T5 | Vinyl acetate 59 (100 g) | 82.7 g H2O | 30 g Zelig GR | 5 g Camphor White oil |
| | | | (2.25 g Clorpirifos) | |
| T6 | Vinyl acetate 59 (100 g) | 46.7 g H2O | 15 g Zelig GR | 5 g Camphor White oil |
| | | | (1.125 g Clorpirifos) | |
| T7 | Raw Linseed oil (100 g) | 25 g Limonene | 40 g Teflustar | 5 g Camphor White oil |
| T8 | Raw Linseed oil (100 g) | 25 g Limonene | 20 g Teflustar | 5 g Camphor White oil |
| T9 | Raw Linseed oil (100 g) | 25 g Limonene | 30 g Zelig GR | 5 g Camphor White oil |
| T10 | Raw Linseed oil (100 g) | 25 g Limonene | 15 g Zelig GR | 5 g Camphor White oil |
| T11 | Raw Linseed oil (100 g) | 25 g Limonene | Not used | Not used |
| T12 | Raw Linseed oil (100 g) | 25 g Limonene | Not used | 5 g Camphor White oil |

| | |
|---|---|
| T13 | No treatment (control) |

At the end of November all the palms involved in the project in Sicily have been sectioned to verify the real infestation.

24 new infestations have been observed, 60 days after the last monitoring: see table 7. The total number of new infestations from the beginning was 71 (36 date palms and 35 Canary palms):

21 controls (no treated): 13 Date palms and 8 Canary palms;

32 palms treated with liquid suspensions insecticide-free:

11 palms treated with vinyl acetate based products (5 with Camphor and 6 without Camphor);

21 palms treated with raw linseed oil based products (10 with Camphor and 11 without Camphor).

3 palms treated with vinyl acetate solution containing insecticide (Teflutrin) at low concentration

2 palms treated with vinyl acetate solution containing insecticide (Teflutrin) at high concentration

4 palms treated with oil solution containing insecticide (Teflutrin) at low concentration

2 palms treated with oil solution containing insecticide (Teflutrin) at high concentration

3 palms treated with oil solution containing insecticide (Clorpirifos) at low concentration

4 palms treated with oil solution containing insecticide (Clorpirifos) at high concentration

The treatments containing insecticides were still reducing the infestations, but after 400 days they were partially losing their efficacy.

Primary recommended materials:

1. Vinyl acetate and Clorpirifos at both dosages (T5 and T6): no infestation was observed after 400 days;

2. Linseed oil and teflutrin or clorpirifos at high dosage (T7 and T9): no infestation was observed after 323 days;

3. Vinyl acetate and teflutrin at both dosages (T2 and T3): no infestation was observed after 245 days;

4. Linseed oil and teflutrin or clorpirifos at low dosage (T8 and T10): no infestation was observed after 245 days.

### Date Palm Results

TABLE 42
Number of Phoenix dactylifera involved in PAD FILM PROJECT
(nursery) and their health state after 400 days of treatments.

| | number | notes |
|---|---|---|
| Treated date palms (healthy) | 264 | |
| Not treated palms (control) | 22 | |
| Number of treatments | 12 | |
| Number of date palms for each treatment | 22 | |
| Number of new palms infested | 5 | after 110 days |
| | 7 | after 152 days |
| | 10 | after 180 days |
| | 13 | after 210 days |
| | 18 | after 245 days |
| | 25 | after 285 days |
| | 29 | after 323 days |
| | 36 | after 400 days |

Twenty-three of the 264 treated date palms and thirteen of 22 untreated were infested after 400 days.

The infested palms belonged to the following treatments (Table 43):

TABLE 43
Phoenix dactylifera infested (after 400 days), quantity and kind of treatment.

| | Number | Number | Number | Number | Number | Number | Number | Number | |
|---|---|---|---|---|---|---|---|---|---|
| | after | after | after | after | after | after | after | after | |
| | 110 | 152 | 180 | 210 | 245 | 285 | 323 | 400 | |
| Treat. | days | days | days | days | days | days | days | days | Notes |
| T1 | 1 | 1 | 2 | 2 | 2 | 2 | 3 | 3 | Treatment with Vinyl acetate, |
| | | | | | | | | | Water and Camphor White oil |
| T3 | 0 | 0 | 0 | 0 | 0 | 1 | 1 | 1 | Treatment with Vinyl |
| | | | | | | | | | acetate, teflutrin (low |
| | | | | | | | | | concentration), Water and |
| | | | | | | | | | Camphor White oil |
| T4 | 0 | 0 | 0 | 0 | 0 | 0 | 1 | 1 | Treatment with Vinyl |
| | | | | | | | | | acetate, Water and |
| | | | | | | | | | Camphor White oil |
| T8 | 0 | 0 | 0 | 0 | 0 | 1 | 1 | 2 | Treatment with Raw |
| | | | | | | | | | Linseed oil, teflutrin (low |
| | | | | | | | | | concentration), Limonene |
| | | | | | | | | | and Camphor White oil |
| T9 | 0 | 0 | 0 | 0 | 0 | 0 | 0 | 2 | Treatment with Raw |
| | | | | | | | | | Linseed oil, clorpirifos |
| | | | | | | | | | (high concentration), |
| | | | | | | | | | Limonene and Camphor |
| | | | | | | | | | White oil |
| T10 | 0 | 0 | 0 | 0 | 0 | 0 | 0 | 1 | Treatment with Raw |
| | | | | | | | | | Linseed oil, clorpirifos |
| | | | | | | | | | (low concentration), |
| | | | | | | | | | Limonene and Camphor |
| | | | | | | | | | White oil |
| T11 | 2 | 3 | 4 | 5 | 6 | 8 | 8 | 8 | Treatment with Raw |
| | | | | | | | | | Linseed oil and |
| | | | | | | | | | Limonene |
| T12 | 0 | 1 | 2 | 2 | 3 | 4 | 4 | 5 | Treatment with Raw |
| | | | | | | | | | Linseed oil, Limonene |
| | | | | | | | | | and Camphor White oil |
| Control | 2 | 2 | 2 | 4 | 7 | 9 | 11 | 13 | No treatment |
| Total | 5 | 7 | 10 | 13 | 18 | 25 | 29 | 36 | |

Comparing the results obtained on date palms with the treatments and controls, after 400 days there is a significant difference between the palm trees untreated and treated with the T11-T12 and all the others (Table 44 and 45):

TABLE 44
Descriptive Statistics of treatments 1-12 and control on
date palms. 36 palms have been infested after 400 days.
There are significant differences (test ANOVA p ≦
0.05). Infested palms were calculated as percentage, where
healthy palm corresponds to 0 and infested palm to 100.

| Treat | Val | Mean ± Std. Error of |
|---|---|---|
| T1 | 22 | 13.63 ± 7.49ab |
| T2 | 22 | 0 ± 0a |
| T3 | 22 | 4.54 ± 4.54ab |
| T4 | 22 | 4.54 ± 4.54ab |
| T5 | 22 | 0 ± 0a |
| T6 | 22 | 0 ± 0a |
| T7 | 22 | 0 ± 0a |
| T8 | 22 | 9.09 ± 6.27ab |
| T9 | 22 | 9.09 ± 6.27ab |
| T10 | 22 | 4.54 ± 4.54ab |
| T11 | 22 | 36.36 ± 10.50c |
| T12 | 22 | 22.73 ± 9.14bc |
| CON | 22 | 59.09 ± 10.73c |

### Canary Palm Results

TABLE 45
Number of Phoenix canariensis involved in PAD FILM PROJECT
(nursery) and their health state after 400 days of treatments.

| | number | Notes |
|---|---|---|
| Treated Canary palms (healthy) | 264 | |
| Not treated palms (control) | 22 | |
| Number of treatments | 12 | |
| Number of date palms for each treatment | 22 | |
| Number of new palms infested | 3 | after 152 days |
| | 4 | after 180 days |
| | 5 | after 210 days |
| | 7 | after 245 days |
| | 11 | after 285 days |
| | 18 | after 323 days |
| | 35 | after 400 days |

Twenty-seven of the 264 treated Canary palms and eight of the untreated were infested after 400 days. The infested palms belonged to the following treatments (Table 46):

TABLE 46
Phoenix canariensis infested (after days), quantity and kind of treatment.

| | Number | Number | Number | Number | Number | Number | Number | Number | |
|---|---|---|---|---|---|---|---|---|---|
| | after | after | after | after | after | after | after | after | |
| | 110 | 152 | 180 | 210 | 245 | 285 | 323 | 400 | |
| Treat. | days | days | days | days | days | days | days | days | notes |
| T1 | 0 | 0 | 0 | 0 | 0 | 0 | 1 | 2 | Treatment with Vinyl acetate, |
| | | | | | | | | | Water and Camphor White oil |
| T2 | 0 | 0 | 0 | 0 | 0 | 1 | 1 | 2 | Treatment with Vinyl acetate, |
| | | | | | | | | | teflutrin (high concentration), |
| | | | | | | | | | Water and Camphor White oil |
| T3 | 0 | 0 | 0 | 0 | 0 | 0 | 1 | 2 | Treatment with Vinyl acetate, |
| | | | | | | | | | teflutrin (low concentration), |
| | | | | | | | | | Water and Camphor White oil |
| T4 | 1 | 1 | 1 | 1 | 2 | 3 | 4 | 5 | Treatment with Vinyl acetate and |
| | | | | | | | | | Water |
| T7 | 0 | 0 | 0 | 0 | 0 | 0 | 0 | 2 | Treatment with Raw Linseed oil, |
| | | | | | | | | | teflutrin (high concentration), |
| | | | | | | | | | Limonene and Camphor White oil |
| T8 | 0 | 0 | 0 | 0 | 0 | 0 | 0 | 2 | Treatment with Raw Linseed oil, |
| | | | | | | | | | teflutrin (low concentration), |
| | | | | | | | | | Limonene and Camphor White oil |
| T9 | 0 | 0 | 0 | 0 | 0 | 0 | 0 | 2 | Treatment with Raw Linseed oil, |
| | | | | | | | | | Clorpirifos (high concentration), |
| | | | | | | | | | Limonene and Camphor White oil |
| T10 | 0 | 0 | 0 | 0 | 0 | 1 | 1 | 2 | Treatment with Raw Linseed oil, |
| | | | | | | | | | Clorpirifos (low concentration), |
| | | | | | | | | | Limonene and Camphor White oil |
| T11 | 0 | 0 | 0 | 0 | 1 | 1 | 1 | 3 | Treatment with Raw Linseed oil |
| | | | | | | | | | and Limonene |
| T12 | 1 | 1 | 1 | 1 | 1 | 1 | 3 | 5 | Treatment with Raw Linseed oil |
| | | | | | | | | | and Limonene and Camphor |
| Control | 1 | 1 | 2 | 3 | 3 | 4 | 6 | 8 | No treatment |
| Total | 3 | 3 | 4 | 5 | 7 | 11 | 18 | 35 | |

Comparing the results obtained on Canary palms, after 400 days there remains a significant difference between the control palm trees and the other treatments (except for T4 and for T12)—see Table 47:

TABLE 47
Descriptive Statistics of treatments 1-12 and control on
Canary palms. 18 palms were infested after 400 days. There
are significant differences (test ANOVA p ≦ 0.05).
Infested palms were calculated as percentage, where healthy
palm corresponds to 0 and infested palm to 100.

| | Valid | |
|---|---|---|
| Treatment | cases | Mean ± Std. Error of Mean |
| T1 | 22 | 9.09 ± 6.27ab |
| T2 | 22 | 9.09 ± 6.27ab |
| T3 | 22 | 9.09 ± 6.27ab |
| T4 | 22 | 22.73 ± 9.14bc |
| T5 | 22 | 0 ± 0a |
| T6 | 22 | 0 ± 0a |
| T7 | 22 | 9.09 ± 6.27a |
| T8 | 22 | 9.09 ± 6.27a |
| T9 | 22 | 9.09 ± 6.27a |
| T10 | 22 | 9.09 ± 6.27ab |
| T11 | 22 | 13.64 ± 7.49bc |
| T12 | 22 | 22.73 ± 9.14cd |
| CONTROL | 22 | 36.36 ± 10.50d |

### Canary and Date Palm Results

After 400 days, 71 palms were infested: 36 date palms and 35 Canary palms. 21 controls, 11 palms treated with vinyl acetate product (without insecticide), 21 palms treated with Raw Linseed Oil (without insecticide), 5 palms treated with vinyl acetate product (with insecticide) and 13 palms treated with Raw Linseed Oil (with insecticide).

TABLE 48
Number of Phoenix spp. involved in PAD FILM PROJECT (nursery)
and their health state after 400 days of treatments.

| | number | notes |
|---|---|---|
| Treated palms (healthy) | 528 | |
| Not treated palms (control) | 44 | |
| Number of treatments | 12 | |
| Number of palms for each treatment | 22 | |
| Number of new palms infested | 8 | after 110 days |
| | 10 | after 152 days |
| | 14 | after 180 days |
| | 18 | after 210 days |
| | 25 | after 245 days |
| | 36 | after 285 days |
| | 47 | after 323 days |
| | 71 | after 400 days |

The infested palms belong to the following treatments:

TABLE 49
Phoenix spp. infested (after 400 days), quantity and kind of treatment.

| | | Number | Number | Number | Number | Number | Number | Number | |
|---|---|---|---|---|---|---|---|---|---|
| | Number | after | after | after | after | after | after | after | |
| | after | 152 | 180 | 210 | 245 | 285 | 323 | 400 | |
| Treatment | 110 days | days | days | days | days | days | days | days | notes |
| T1 | 1 | 1 | 2 | 2 | 2 | 2 | 4 | 5 | Treatment with |
| | | | | | | | | | Vinyl acetate, |
| | | | | | | | | | Water and |
| | | | | | | | | | Camphor White |
| | | | | | | | | | oil |
| T2 | 0 | 0 | 0 | 0 | 0 | 1 | 1 | 2 | Treatment with |
| | | | | | | | | | Vinyl acetate, |
| | | | | | | | | | teflutrin (high |
| | | | | | | | | | concentration), |
| | | | | | | | | | Water and |
| | | | | | | | | | Camphor White |
| | | | | | | | | | oil |
| T3 | 0 | 0 | 0 | 0 | 0 | 1 | 2 | 3 | Treatment with |
| | | | | | | | | | Vinyl acetate, |
| | | | | | | | | | teflutrin (low |
| | | | | | | | | | concentration), |
| | | | | | | | | | Water and |
| | | | | | | | | | Camphor White |
| | | | | | | | | | oil |
| T4 | 1 | 1 | 1 | 1 | 2 | 3 | 5 | 6 | Treatment with Vinyl |
| | | | | | | | | | acetate and Water |
| T7 | 0 | 0 | 0 | 0 | 0 | 0 | 0 | 2 | Treatment with |
| | | | | | | | | | Raw Linseed |
| | | | | | | | | | oil, teflutrin |
| | | | | | | | | | (high |
| | | | | | | | | | concentration), |
| | | | | | | | | | Limonene and |
| | | | | | | | | | Camphor White |
| | | | | | | | | | oil |
| T8 | 0 | 0 | 0 | 0 | 0 | 1 | 1 | 4 | Treatment with |
| | | | | | | | | | Raw Linseed |
| | | | | | | | | | oil, teflutrin |
| | | | | | | | | | (low |
| | | | | | | | | | concentration), |
| | | | | | | | | | Limonene and |
| | | | | | | | | | Camphor White |
| | | | | | | | | | oil |
| T9 | 0 | 0 | 0 | 0 | 0 | 0 | 0 | 4 | Treatment with |
| | | | | | | | | | Raw Linseed |
| | | | | | | | | | oil, Clorpirifos |
| | | | | | | | | | (lhigh |
| | | | | | | | | | concentration), |
| | | | | | | | | | Limonene and |
| | | | | | | | | | Camphor White |
| | | | | | | | | | oil |
| T10 | 0 | 0 | 0 | 0 | 0 | 1 | 1 | 3 | Treatment with |
| | | | | | | | | | Raw Linseed |
| | | | | | | | | | oil, Clorpirifos |
| | | | | | | | | | (low |
| | | | | | | | | | concentration), |
| | | | | | | | | | Limonene and |
| | | | | | | | | | Camphor White |
| | | | | | | | | | oil |
| T11 | 2 | 3 | 4 | 5 | 7 | 9 | 9 | 11 | Treatment with |
| | | | | | | | | | Raw Linseed oil |
| | | | | | | | | | and Limonene |
| T12 | 1 | 2 | 3 | 3 | 4 | 5 | 7 | 10 | Treatment with |
| | | | | | | | | | Raw Linseed |
| | | | | | | | | | oil, Limonene |
| | | | | | | | | | and Camphor |
| | | | | | | | | | White oil |
| Control | 3 | 3 | 4 | 7 | 10 | 13 | 17 | 21 | No treatment |
| Total | 8 | 10 | 14 | 18 | 25 | 36 | 47 | 71 | |

Comparing the results obtained after 400 days there was a significant difference between controls and the other treatments (Table 50):

TABLE 50
Descriptive Statistics of treatment 1-12 and control on date
and Canary palms (572 palm trees). 71 palms were infested after
400 days. There were significant differences (test ANOVA p ≦
0.05). Infested palms were calculated as percentage, where healthy
palm corresponds to 0 and infested palm to 100.

| | Valid | Mean ± Std. Error |
|---|---|---|
| Treatment | cases | of Mean |
| T1 | 44 | 11.36 ± 4.84bc |
| T2 | 44 | 4.54 ± 3.17ab |
| T3 | 44 | 4.83 ± 3.84ab |
| T4 | 44 | 13.64 ± 5.23bc |
| T5 | 44 | 0 ± 0a |
| T6 | 44 | 0 ± 0a |
| T7 | 44 | 4.54 ± 3.18ab |
| T8 | 44 | 9.09 ± 4.38bc |
| T9 | 44 | 9.09 ± 4.38bc |
| T10 | 44 | 6.82 ± 3.84ab |
| T11 | 44 | 25.00 ± 6.60cd |
| T12 | 44 | 22.73 ± 6.39cd |
| CONTROL | 44 | 47.73 ± 7.62e |

At the end of the trials, after 400 days, 27.3% of date palms and 20.9% of Canary palms not treated or treated with insecticide free solutions were infested.

After 400 days, 3.4% of date palms and 6.8% of Canary palms treated with insecticide solutions were infested.

In total, after 400 days, 47.7% of controls (59% control date palms and 36.3% control Canary palms), 18.2% of palms treated without insecticide and 5.1% of treated with insecticide solutions were infested.

As observed 323 days after treatments, a damping of the insecticide effect is in progress: only on the palms (Date and Canary) treated with Vinyl acetate and Chlorpyrifos (T5 and T6) was no infestation observed.

### Field Trial (Spain)

From 21 to 28 Aug. 2014, ANT's experts carried out treatments on date palms in open field in Elche (Spain). This area is characterized by many farms with date palms and nearby the “Palmeral” of Elche was declared a World Heritage Site by UNESCO.

The products were applied using an electric sprayer (pressure 0.32 bar). Healthy palm trees involved in the experiment were treated on the first meters of trunk (0-2 m maximum). The products were the same used in previous trials in Italy, with the exception of product Inesfly (Inespalm).

Fifty-six adult palm trees (Phoenix dactylifera) were used:
7 palms not treated (control);
7 palms treated with vinyl acetate+clorpirifos low dosage (ANT-T6);
7 palms treated with vinyl acetate+clorpirifos high dosage (ANT-T5);
7 palms treated with vinyl acetate+teflutrin high dosage (ANT-T2);
7 palms treated with vinyl acetate+teflutrin low dosage (ANT-T3);
7 palms treated with oil+clorpirifos high dosage (ANT-T9);
7 palms treated with oil+teflutrin high dosage (ANT-T7);
7 palms treated with a “commercial” product (inespalm).

Seven palms were considered for each treatment.

The trial was carried out in a palm grove 11.5 km south from Elche (see FIGS. 1 and 5). Starting from an amount of 2,500 date palms, 92 palms selected as sure healthy palms with more than two off-shoots at first, then 56 date palms useful for the trial palms finally selected.

Each palm had two off-shoots; supernumerary ones palms removed and treatments palms carried out immediately after. Six hundred grams of product were applied to each palm.

The area was naturally infested by Red Palm Weevil.

The test lasted about 3 months.

On 6^{th} and 7^{th} October a visual inspection was carried out to check the presence of infested palm trees. From 11 to 15 November, visual and instrumental inspections were carried out with the same aim.

### Results

After 45 days of treatments, 4 palms were naturally infested according to visual inspection. The infested palms belonged to the following treatments: control, Inespalm, ANT-T7 and ANT-T9.

After 83 days, 7 palms were infested: 3 controls, 2 treated with Inespalm, 1 treated with ANT-T7 and 1 treated with ANT-T9 (see Table 51 below).

TABLE 51
Number of infested palm trees for each
treatment (test ANOVA p ≦ 0.05).

| | Number | Number | |
|---|---|---|---|
| | after | after | |
| Treatment | 45 days | 83 days | notes |
| ANT-T2 | 0 | 0 a | Treatment with Vinyl acetate, |
| | | | teflutrin (high concentration), |
| | | | Water and Camphor White oil |
| ANT-T3 | 0 | 0 a | Treatment with Vinyl acetate, |
| | | | teflutrin (low concentration), |
| | | | Water and Camphor White oil |
| ANT-T5 | 0 | 0 a | Treatment with Vinyl acetate, |
| | | | chlorpirifos (high concentration), |
| | | | Water and Camphor White oil |
| ANT-T6 | 0 | 0 a | Treatment with Vinyl acetate, |
| | | | chlorpirifos (low concentration), |
| | | | Water and Camphor White oil |
| ANT-T7 | 1 | 1 (14%) ab | Treatment with Raw Linseed oil, |
| | | | teflutrin (high concentration), |
| | | | Limonene and Camphor White oil |
| ANT-T9 | 1 | 1 (14%) ab | Treatment with Raw Linseed oil, |
| | | | chlorpirifos (high concentration), |
| | | | Limonene and Camphor White oil |
| INESPALM | 1 | 2 (29%) ab | |
| Control | 1 | 3 (43%) b | No treatment |
| Total | 4 | 7 | |

After almost three months, the products with vinyl acetate glue seem more effective than others.

U.S. provisional patent applications 62/010,317 and 62/142,919 are incorporated herein by reference in their entireties.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A palm plant treatment method, comprising:
applying a composition comprising an insecticide and a polymeric adhesive to an exterior surface of a palm plant to form an insecticide-containing layer comprising a homogenous mixture of the insecticide and the polymeric adhesive which is in direct contact with the surface of the palm plant,
wherein the insecticide-containing layer is effective for treating or preventing infestation of the palm plant by a pest without the insecticide entering the vascular system of the palm plant.

2. The method of claim 1, wherein the composition further comprises a repellant and the applying forms an insecticide-containing layer further comprising the repellant.

3. The method of claim 1, wherein the insecticide-containing layer remains on the surface of the palm plant for at least 3 months during which there is no infestation of the palm tree by the pest.

4. The method of claim 1, wherein the insecticide is selected from the group consisting of tefluthrin and chlorpyrifos.

5. The method of claim 1, wherein the pest is a red palm weevil and the palm plant is a palm tree.

6. The method of claim 1, wherein the polymeric adhesive is selected from the group consisting of polyvinyl acetate and raw linseed oil.

7. The method of claim 1, wherein the palm plant is selected from the group consisting of Phoenix dactylifera and Phoenix canariensis.

8. The method of claim 1, wherein the insecticide-containing layer continuously covers the severed and live leaf bases and petiole bases of the palm plant.

9. The method of claim 1, wherein the composition further comprises at least one of an aqueous solvent or an organic solvent.

10. The method of claim 1, wherein the polymeric adhesive is selected from the group consisting of polyvinyl acetate, methyl cellulose, polyvinyl alcohol, polyvinylidene chloride, polyacrylic, cellulose, polyvinylpyrrolidone, polysaccharide, natural latex, and synthetic latex.

11. A pest resistant palm plant surface, comprising:
an exterior surface of a palm plant and an insecticide-containing layer comprising a homogenous mixture of the insecticide and the polymeric adhesive,
wherein the insecticide-containing layer is in direct contact with the surface of the palm plant, and
wherein the insecticide-containing layer is effective for treating or preventing infestation of the palm plant by a pest without the insecticide entering the vascular system of the palm plant.

12. The pest resistant palm plant surface of claim 11, wherein the insecticide-containing layer further comprises a repellant.

13. The pest resistant palm plant surface of claim 11, wherein the insecticide-containing layer is present on the surface of the palm plant in an amount and a thickness effective for preventing infestation of the palm plant by the pest for at least 3 months.

14. The pest resistant palm plant surface of claim 11, wherein the insecticide is selected from the group consisting of tefluthrin and chlorpyrifos.

15. The pest resistant palm plant surface of claim 11, wherein the pest is a red palm weevil and the palm plant is a palm tree.

16. The pest resistant palm plant surface of claim 11, wherein the polymeric adhesive is selected from the group consisting of polyvinyl acetate and raw linseed oil.

17. The pest resistant palm plant surface of claim 11, wherein the palm plant is selected from the group consisting of Phoenix dactylifera and Phoenix canariensis.

18. The pest resistant palm plant surface of claim 11, wherein the insecticide-containing layer continuously covers the severed and live leaf bases and petiole bases of the palm plant.

19. An insecticide for preventing infestation of palm trees by a red palm weevil, comprising:
a polyvinyl acetate adhesive, chlorpyrifos and camphor oil, wherein the chlorpyrifos and the camphor oil are homogenously dispersed in the polyvinyl acetate adhesive.

20. An insecticide for preventing infestation of palm trees by a red palm weevil, comprising:
a polyvinyl acetate adhesive and chlorpyrifos, wherein the chlorpyrifos is homogenously dispersed in the polyvinyl acetate adhesive.

21. An insecticide for preventing infestation of palm trees by a red palm weevil, comprising:
a polyvinyl acetate adhesive, teflutrin and camphor oil, wherein the teflutrin and the camphor oil are homogenously dispersed in the polyvinyl acetate adhesive.

22. An insecticide for preventing infestation of palm trees by a red palm weevil, comprising:
a polyvinyl acetate adhesive and teflutrin, wherein the tefluthrin is homogenously dispersed in the polyvinyl acetate adhesive.
